(19) United States
(12) Patent Application Publication
(10) Pub. No.: US 2016/0348032 A1
(43) Pub. Date: Dec. 1, 2016

(54) USE OF ORTHO-SUBSTITUTED ETHOXYLATED AL OR ZN-PHTHALOCYANINE COMPOUNDS AS PHOTOBLEACH AGENTS IN LAUNDRY DETERGENTS

(71) Applicant: BASF SE, Ludwigshafen (DE)

(72) Inventors: Frank BACHMANN, Freiburg (DE); Gunther SCHLINGLOFF, Mannheim (DE); Peter HUBNER, Endingen (DE); Catharina WOHLMUTH, Ludwigshafen (DE)

(21) Appl. No.: 15/115,025

(22) PCT Filed: Dec. 19, 2014
(86) PCT No.: PCT/EP2014/078642

§ 371 Date: Jul. 28, 2016

(30) Foreign Application Priority Data
Jan. 31, 2014 (EP) 14153406.5

(51) Int. Cl. C11D 3/00; C11D 3/39; C11D 17/06; C11D 3/16

(52) U.S. Cl. CPC C11D 3/0063; C11D 3/168; C11D 3/3932; C11D 17/06

(57) ABSTRACT

The present invention relates to the use of ortho-substituted ethoxylated Al or Zn-phthalocyanine compounds as photobleach agents for the removal of stains and soil on textile materials, particularly in laundry detergents. A further aspect of the invention is a process for removing stains and soil from textile materials using the Al or Zn-phthalocyanine compounds in a washing process and exposing the washed textile material to actinic radiation. Still further aspects are detergent and granule formulations containing ortho-substituted ethoxylated Al or Zn-phthalocyanine compounds and also new orthosubstituted ethoxylated Zn-phthalocyanine compounds as such.

The present invention relates to the use of ortho-substituted ethoxylated Al or Zn-phthalocyanine compounds as photobleach agents for the removal of stains and soil on textile materials, particularly in laundry detergents. A further aspect of the invention is a process for removing stains and soil from textile materials using the Al or Zn-phthalocyanine compounds particularly in a washing process and exposing the washed textile material to actinic radiation. Still further aspects are detergent and granule formulations containing ortho-substituted ethoxylated Al or Zn-phthalocyanine compounds and new orthosubstituted ethoxylated Zn-phthalocyanine compounds as such.

It is well know that certain water soluble phthalocyanine, naphthocyanine and metallocyanine compounds can be used as photobleaching agents. This is, for example described in WO 98/32826 wherein a summary of patent documents and other references for the use as photobleaches, their synthesis and formulation is outlined on pages 3 to 4.

Phthalocyanines and naphthalocyanines or their metal complexes can form “singlet oxygen” an oxidative species capable of reacting with stains to bleach them to a colorless and usually water-soluble state.

There are many examples of phthalocyanine and naphthalocyanine photobleaches, the most common being the zinc and aluminum phthalocyanines. In the literature the term “photosensitizer” is often used instead of “photoactivator” both terms may be used as synonyms for photobleach agent which is used throughout this specification.

A major problem associated with prior art phthalocyanine photobleaches is the fact that these molecules are highly colored materials, having an absorption band in the range 600 to 700 nm. When used on white fabrics the compounds can only be used in very low concentrations which limit their bleaching efficiency. Furthermore they may accumulate after several wash cycles and then cause an undesired discoloration of the fabric.

It has been an object of the instant invention to provide phthalocyanine photobleaches, which can easily be used for the bleaching of white fabrics without imparting colour after several washing/bleaching cycles to the fabric. The phthalocyanine photobleaches should be water soluble to such an extent that they can be used in washing and detergent solutions. They should be useful also in liquid detergents. Their substantivity should be adjustable for cotton and also for synthetic fabrics as well as mixtures thereof.

In household laundry processes it is desirable achieving a high uptake of the photobleaches. The photobleach molecules should, however, not exhaust in localized (micro)spots. The concentration should be equally distributed over the fabric. This feature is often called levelling property. A good levelling property means that there is no or almost no spectroscopic difference between a spot and the surrounding/background. The extent of leveling depends not only on the way of pre-treatment but also on the detergent formulation, the washing conditions, concentration levels, affinity/substantivity and the kind of phthalocyanine photobleach. A good levelling property is a prerequisite to avoid spotting or staining on the fabrics which may otherwise be caused by coloured ingredients, such as photobleach agents.

Very commonly, in particular liquid detergents are directly applied on the fabric by the consumer without prior dilution. Due to this consumer habit undesired discoloration may occur on the fabric.

It has been found that specific ortho-substituted ethoxylated Zn-phthalocyanine compounds solve the above mentioned problems and still show a high activity as photobleach agents.

One aspect of the invention is the use of an ortho substituted compound of formula Ia or Ib and their position isomers as photobleach agent for the removal of stains and soil on textile materials

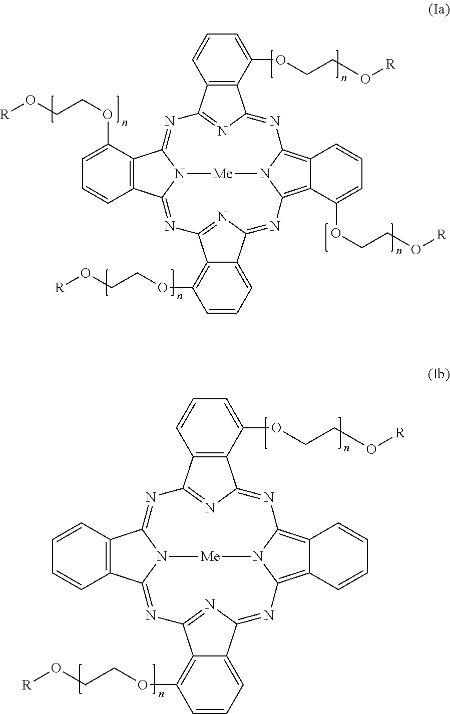

wherein

### Me is Zn or Al—X,

X is halogen, OH or O—CH₂—CH₂—OR,
R is H or C₁-C₈alkyl, preferably CH₃ and
n is a number from 1 to 80.

The compounds of formula Ia or Ib are useful as photobleach agent for the removal of stains and soil on textile materials

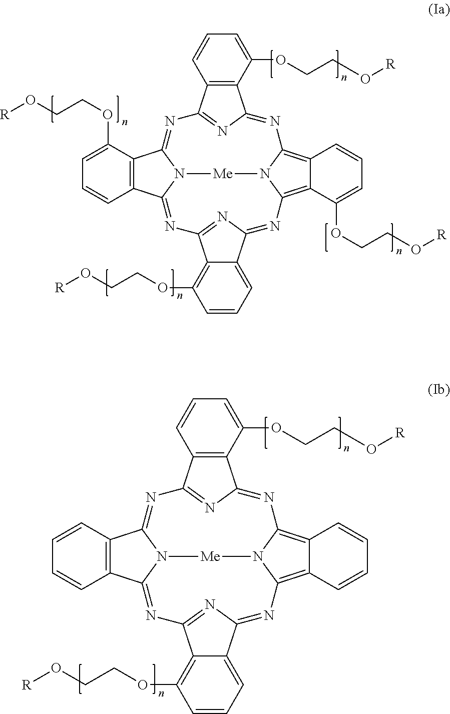

wherein

### Me is Zn or Al—X,

X is halogen, OH or O—CH₂—CH₂—OR,
R is H or C₁-C₈alkyl, preferably CH₃ and
n is a number from 1 to 80.

Preferably in formulae (Ia) and (Ib) Me is Zn.

In a specific embodiment of the invention the photobleach agent is of formula (Ia) and R and n have the meaning as defined above.

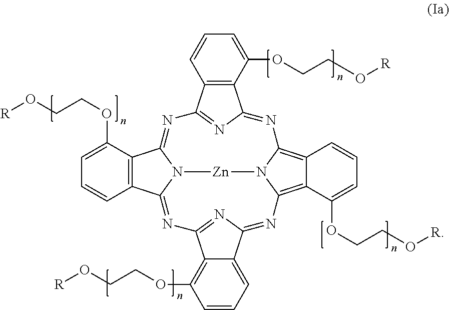

The compounds of formula (Ia) and (Ib) are preferably ortho-substituted ethoxylated Znphthalocyanines. The term ortho means that the substitution of the ethoxylate residue at the benzene ring is adjacent to the anellated pyrrol ring. There exist a variety of position isoisomers and mixtures thereof, which are embraced by the idealized formulas (Ia) and (Ib).

Examples of such position isomers for compounds of formula (Ia) and (Ib) are given below.

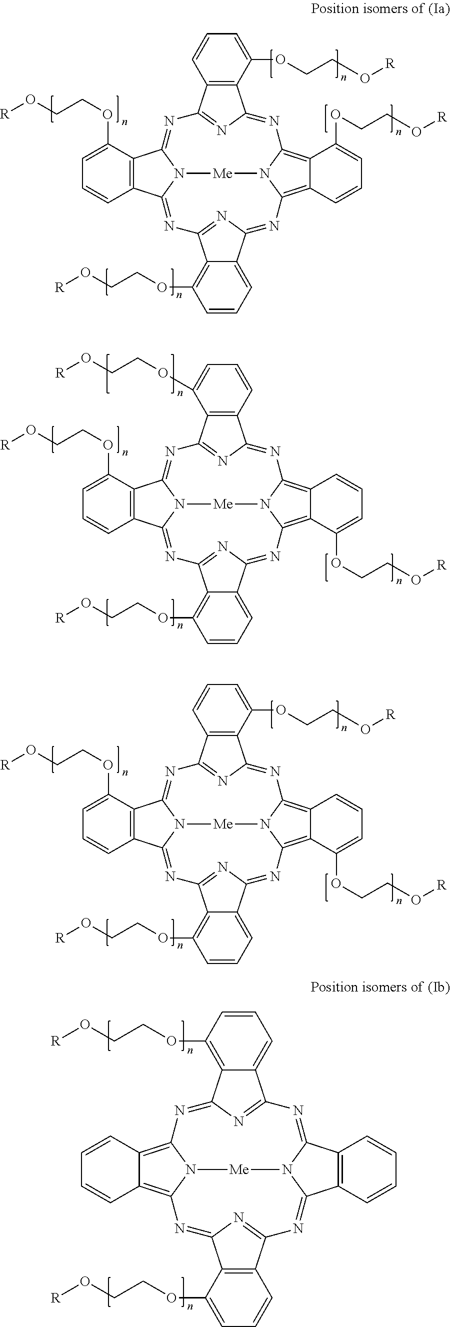

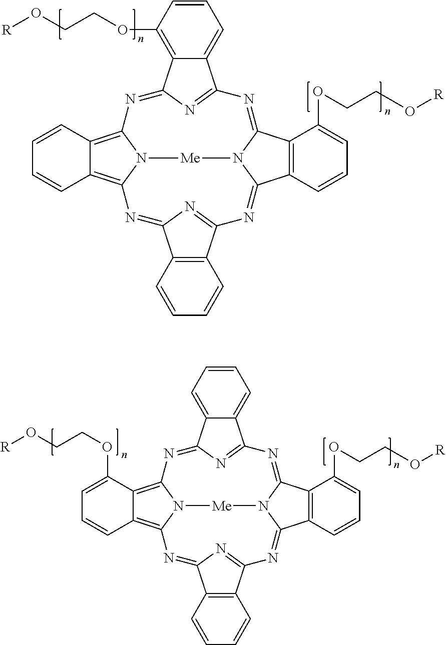

In a specific embodiment of the invention n is a number from 7 to 70, preferably from 7 to 40 and more preferably from 7 to 25.

Preferably the compounds of formula (Ia) or (Ib) are used in the context of an aqueous cleaning, washing or bleaching process.

The synthesis of the compounds of formula (Ia) or (Ib) is carried out according to standard procedures.

The synthesis of zinc phthalocyanines is, for example, described in
P. Erk and H. Hengelsberg, in The Porphyrin Handbook, Vol. 19, 105 (2003),
C. C. Leznoff, in Phthalocyanines (Ed: C. C. Leznoff) VCH Publishers, New York, 1989, Chapter 1, 1-54.
Water soluble zinc phthalocyanines are, for example, described in DE2613936A, DE2813198 and EP81462.

Ahsen et al also mention the existence of position isomers (s. structure 2 on page 4068 of the cited article).

Water soluble aluminium phthalocyanines and their preparation are described EP26744, EP35470 or by Kobayashi et al., Bull. Chem. Soc. Jpn. 72, 1263 (1999), Ahsen et al. Dalton Trans. 40 (2011), 4067 and Yang et al. J. Photochem. Photobiol. A: Chem. 207 (2009), 58.

The synthesis of o-ethoxylated zinc phthalocyanines is possible by reaction of a reactive orthosubstituted phthalodinitrile with the corresponding ethylenglycol, ethylenglycolmonomethyiether or polyalkylenglycol derivatives (trade name Pluriol®, BASF) and subsequent cyclotetramerization with zinc salts,

### Synthesis of o-Ethoxylated Zinc Phthalocyanines is Subsequently Outlined

### 1) General Procedure for the Synthesis of o-Ethoxylated Phthalonitriles

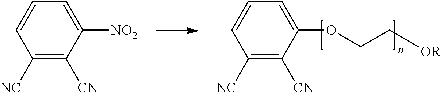

6 mmol 3-nitrophthalonitrile and 60 mmol of the corresponding ethylene glycol or ethyleneglycol monomethylether derivative are dissolved in 20 ml of dry N,N-dimethylformamide (DMF). Under stirring and N₂-atmosphere, around 30 mmol of potassium carbonate is added to the solution. The reaction solution is stirred at 20° C. for at least 10 hours. Afterwards, the reaction is monitored by TLC (solvent ethylacetate/heptane 4:1). When no more 3-nitrophthalonitrile is detected, the product mixture is worked-up. Otherwise, stirring at room temperature is continued until the reaction is complete.
Work-up: The resulting suspension is filtrated. 100 ml of dichloromethane is added to the clear reaction mixture. The obtained organic solution is washed three times with 100 ml of water. The organic layer is dried with magnesium sulfate, filtrated and evaporated. The crude product is dried in vacuo at 35° C. for 4 hours and directly used for the phthalocyanine synthesis.

Purification: If necessary, the o-ethoxylated phthalonitriles are purified by preparative HPLC (Combiflash) with the following system: RediSep Silica column with ethylacetate, methanol and heptane as solvents, flow rate 40 ml/min. UV-Detection of the product is done at 280 nm.

### 2) General Procedure for the Synthesis of o-Ethoxylated Zinc Phthalocyanines

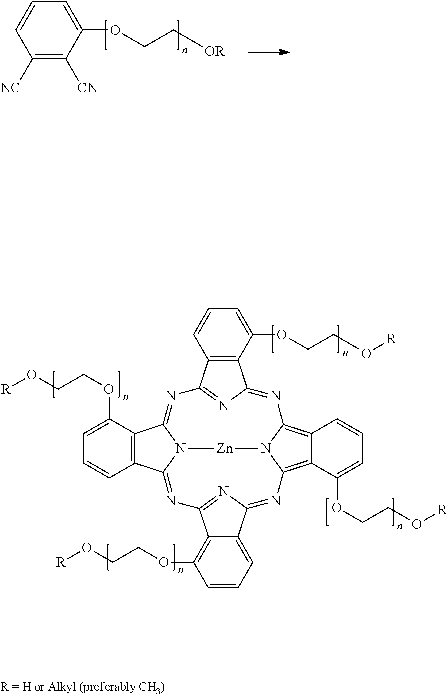

5.0 mmol of the corresponding o-ethoxylated phthalonitrile, 1.2 mmol anhydrous zinc chloride and 5 mmol 1,8-diazabicyclo[5.4.0]undec-7-en (DBU) are suspended in 20 ml 1-pentanol. Under stirring and N₂-atmosphere, the suspension is heated to 135° C. and kept at this temperature for 12 hours.

Work-up: The green reaction solution is cooled to 20° C. and then poured into an excess of heptane (around 100 ml). A dark oily layer is formed which is decanted and taken up with 50 ml dichloromethane. The organic phase is evaporated in vacuo to give the crude product as a dark green solid or oil.

Purification: If necessary, the o-ethoxylated zinc phthalocyanines are purified by preparative HPLC with the same Combiflash as described above. As solvents, a mixture of dichloromethane and methanol is used.

Another aspect of the invention is a detergent, cleaning, washing or bleaching composition comprising
I) from 1 to 50 wt-%, based on the total weight of the composition, A) of at least one anionic surfactant and/or B) of a non-ionic surfactant,
II) from 0 to 70 wt-%, based on the total weight of the composition, C) of at least one builder substance,
III) 99 wt-%, based on the total weight of the composition, D) of at least one peroxide and/or one peroxide-forming substance,
IV) E) at least 0.001% to 10% based on the total weight of the composition of at least one compound of formula (Ia) or (Ib) as defined above,
V) 0-20 wt-%, based on the total weight of the composition, of at least one further additive, and
VI) water ad 100 wt-%, based on the total weight of the composition.

Preferably the composition is used for the treatment of a textile material.

All wt-% are based on the total weight of the detergent, cleaning, washing or bleaching composition.

The detergent, cleaning, washing or bleaching composition can be any kind of industrial or domestic cleaning, washing or bleaching formulation.

The compositions preferably contain from 0.005 to 2 wt-% of at least one compound of formula (Ia) or (Ib), more preferably from 0.01 to 1 wt-% and most preferably from 0.05 to 1 wt-%.

Therefore in a specific embodiment of the present invention the detergent, cleaning, washing or bleaching composition comprises
I) from 1-50 wt-%, preferably from 1-30 wt-% by. A) of at least one anionic surfactant and/or B) of a non-ionic surfactant,
II) from 0-70 wt-%, preferably from 0-50 wt-%, C) of at least one builder substance.
III) from 0-99 wt-%, preferably 0-50 wt-%, D) of at least one peroxide and/or at least one peroxide-forming substance,
IV) from 0.005-2 wt-%, more preferably from 0.01-1 wt-% and most preferably from 0.05-1 wt-% E) of at least one compound of formula (Ia) or (Ib) as defined above,
V) from 0-20 wt-% of at least one further additive, and
VI) water ad 100% by weight.

When the compositions according to the invention comprise a component C), the amount thereof is preferably from 1 to 70 wt-%, especially from 1 to 50 wt-%. Special preference is given to an amount of from 5 to 50 wt-% and especially an amount of from 10 to 50 wt-%.

Corresponding washing, cleaning or bleaching processes are usually carried out by using an aqueous liquor containing from 0.1 to 200 mg of one or more compounds of formula (Ia) or (Ib) per litre of liquor. The liquor preferably contains from 1 to 50 mg of at least one compound of formula (Ia) or (Ib) per litre of liquor.

The composition according to the invention can be, for example, a peroxide-containing heavy-duty detergent or a separate bleaching additive, or a stain remover that is to be applied directly. A bleaching additive is used for removing coloured stains on textiles in a separate liquor before the clothes are washed with a bleach-free detergent. A bleaching additive can also be used in a liquor together with a bleach-free detergent.

Stain removers can be applied directly to the textile in question and are used especially for pretreatment in the event of heavy local soiling.

The stain remover can be applied in liquid form, by a spraying method or in the form of a solid substance, such as a powder especially as a granule.

Granules can be prepared, for example, by first preparing an initial powder by spray-drying an aqueous suspension comprising all the components listed above except for component E), and then adding the dry component E) and mixing everything together. It is also possible to add component E) to an aqueous suspension containing components A), B), C) and D) and then to carry out spray-drying.

It is also possible to start with an aqueous suspension that contains components A) and C), but none or only some of component B). The suspension is spray-dried, then component E) is mixed with component B) and added, and then component D) is mixed in the dry state. It is also possible to mix all the components together in the dry state.

The anionic surfactant A) can be, for example, a sulfate, sulfonate or carboxylate surfactant or a mixture thereof. Preference is given to alkylbenzenesulfonates, alkyl sulfates, alkyl ether sulfates, olefin sulfonates, fatty acid salts, alkyl and alkenyl ether carboxylates or to an α-sulfonic fatty acid salt or an ester thereof.

Preferred sulfonates are, for example, alkylbenzenesulfonates having from 10 to 20 carbon atoms in the alkyl radical, alkyl sulfates having from 8 to 18 carbon atoms in the alkyl radical, alkyl ether sulfates having from 8 to 18 carbon atoms in the alkyl radical, and fatty acid salts derived from palm oil or tallow and having from 8 to 18 carbon atoms in the alkyl moiety. The average molar number of ethylene oxide units added to the alkyl ether sulfates is from 1 to 20, preferably from 1 to 10. The cation in the anionic surfactants is preferably an alkaline metal cation, especially sodium or potassium, more especially sodium. Preferred carboxylates are alkali metal sarcosinates of formula R₁₉—CON(R₂₀)C₂COOM₁ wherein R₁₉ is C₉-C₁₇alkyl or C₉-C₁₇alkenyl, R₂₀ is C₁-C₄alkyl and M₁ is an alkali metal, especially sodium.

The non-ionic surfactant B) may be, for example, a primary or secondary alcohol ethoxylate, especially a C₈-C₂₀ aliphatic alcohol ethoxylated with an average of from 1 to 20 mol of ethylene oxide per alcohol group. Preference is given to primary and secondary C₁₀-C₁₅ aliphatic alcohols ethoxylated with an average of from 1 to 10 mol of ethylene oxide per alcohol group. Non-ethoxylated non-ionic surfactants, for example alkylpolyglycosides, glycerol monoethers and polyhydroxyamides (glucamide), may likewise be used.

The total amount of anionic and non-ionic surfactants is preferably from 5 to 50 wt-%, especially from 5 to 40 wt-% and more especially from 5 to 30 wt-%. The lower limit of those surfactants to which even greater preference is given is 10 wt-%.

In addition to anionic and/or non-ionic surfactants the composition may contain cationic surfactants. Possible cationic surfactants include all common cationic surface-active compounds, especially surfactants having a textile softening effect.

Non-limited examples of cationic surfactants are given in the formulas below:

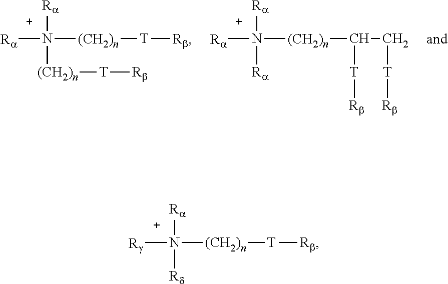

wherein
each radical is independent of the others C₁₋₆-alkyl-, -alkenyl- or -hydroxyalkyl; each radical R_{β}, is independent of the others C₈₋₂₈-alkyl- or alkenyl;
R_{γ} is R_{α} or (CH₂)ₙ-T-R_{β};
R_{δ} is R_{α} or R_{β} or (CH₂)ₙ-T-R_{β}; T=—CH₂—, —O—CO— or —CO—O— and
n is between 0 and 5.

Preferred cationic surfactants present in the composition according to the invention include hydroxyalkyl-trialkyl-ammonium-compounds, especially C₁₂₋₁₈-alkyl(hydroxyethyl)dimethylammonium compounds, and especially preferred the corresponding chloride salts. Compositions of the present invention can contain between 0.5 wt-% and 15 wt-% of the cationic surfactant, based on the total weight of the compostion.

As builder substance C) there come into consideration, for example, alkali metal phosphates, especially tripolyphosphates, carbonates and hydrogen carbonates, especially their sodium salts, silicates, aluminum silicates, polycarboxylates, polycarboxylic acids, organic phosphonates, aminoalkylenepoly(alkylenephosphonates) and mixtures of such compounds.

Silicates that are especially suitable are sodium salts of crystalline layered silicates of the formula NaHSiₜO₂ₜ₊₁.pH₂O or Na₂SiₜO₂ₜ₊₁.pH₂O wherein t is a number from 1.9 to 4 and p is a number from 0 to 20.

Among the aluminum silicates, preference is given to those commercially available under the names zeolite A, B, X and HS, and also to mixtures comprising two or more of such components. Special preference is given to zeolite A.

Among the polycarboxylates, preference is given to polyhydroxycarboxylates, especially citrates, and acrylates, and also to copolymers thereof with maleic anhydride. Preferred polycarboxylic acids are nitrilotriacetic acid, ethylenediaminetetraacetic acid and ethylenediamine disuccinate either in racemic form or in the enantiomerically pure (S,S) form.

Phosphonates or aminoalkylenepoly(alkylenephosphonates) that are especially suitable are alkali metal salts of 1-hydroxyethane-1,1-diphosphonic acid, nitrilotris(methylenephosphonic acid), ethylenediaminetetramethylenephosphonic acid and diethylenetriaminepentamethylenephosphonic acid, and also salts thereof. Also preferred polyphosphonates have the following formula

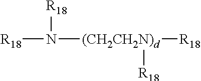

wherein
R₁₈ is CH₂PO₃H₂ or a water soluble salt thereof and d is an integer of the value 0, 1, 2 or 3.

Especially preferred are the polyphosphonates wherein b is an integer of the value of 1.

The amount of the peroxide or the peroxide-forming substance D) is preferably 0.5-30 wt-%, more preferably 1-20 wt-% and especially preferably 1-15 wt-%.

As the possible peroxide component D) there come into consideration every compound which is capable of yielding hydrogen peroxide in aqueous solutions, for example, the organic and inorganic peroxides known in the literature and available commercially that bleach textile materials at conventional washing temperatures, for example at from 10 to 95° C.

Preferably, however, inorganic peroxides are used, for example persulfates, perborates, percarbonates and/or persilicates.

Examples of suitable inorganic peroxides are sodium perborate tetrahydrate or sodium perborated monohydrate, sodium percarbonate, inorganic peroxyacid compounds, such as for example potassium monopersulphate (MPS). If organic or inorganic peroxyacids are used as the peroxygen compound, the amount thereof will normally be within the range of about 2-80 wt-%, preferably from 4-30 wt-%.

The organic peroxides are, for example, mono- or poly-peroxides, urea peroxides, a combination of a C₁-C₄alkanol oxidase and C₁-C₄alkanol (Such as methanol oxidase and ethanol as described in WO95/07972), alkylhydroxy peroxides, such as cumene hydroperoxide and t-butyl hydroperoxide.

The peroxides may be in a variety of crystalline forms and have different water contents, and they may also be used together with other inorganic or organic compounds in order to improve their storage stability.

All these peroxy compounds may be utilized alone or in conjunction with a peroxyacid bleach precursor and/or an organic bleach catalyst not containing a transition metal. Generally, the bleaching composition of the invention can be suitably formulated to contain from 2 to 80 wt-%, preferably from 4 to 30 wt-%, of the peroxy bleaching agent.

As oxidants, peroxo acids can also be used. One example is organic mono peracids of formula

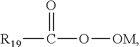

wherein
M signifies hydrogen or a cation,
R₁₉ signifies unsubstituted C₁-C₁₈alkyl; substituted C₁-C₁₈alkyl; unsubstituted aryl; substituted aryl; —(C₁-C₆alkylene)-aryl, wherein the alkylene and/or the alkyl group may be substituted; and phthalimidoC₁-C₈alkylene, wherein the phthalimido and/or the alkylene group may be substituted.

Preferred mono organic peroxy acids and their salts are those of formula

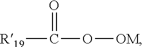

wherein
M signifies hydrogen or an alkali metal, and
R′₁₉ signifies unsubstituted C₁-C₄alkyl; phenyl; —C₁-C₂alkylene-phenyl or phthalimidoC₁-C₈alkylene.

Especially preferred is CH₃COOOH and its alkali salts.

Especially preferred is also ε-phthalimido peroxy hexanoic acid and its alkali salts.

Also suitable are diperoxyacids, for example, 1,12-diperoxydodecanedioic acid (DPDA), 1,9-diperoxyazelaic acid, diperoxybrassilic acid, diperoxysebasic acid, diperoxyisophthalic acid, 2-decyldiperoxybutane-1,4-diotic acid and 4,4′-sulphonylbisperoxybenzoic acid.

Instead of the peroxy acid it is also possible to use organic peroxy acid precursors and H₂O₂. Such precursors are the corresponding carboxyacid or the corresponding carboxyanhydrid or the corresponding carbonylchlorid, or amides, or esters, which can form the peroxy acids on perhydrolysis. Such reactions are commonly known.

Peroxyacid bleach precursors are known and amply described in literature, such as in the British Patents 836988; 864,798; 907,356; 1,003,310 and 1,519,351; German Patent 3,337,921; EP-A-0185522; EP-A-0174132; EP-A-0120591; and U.S. Pat. Nos. 1,246,339; 3,332,882; 4,128,494; 4,412,934 and 4,675,393.

Peroxy acid precursors are often referred to as bleach activators. Suitable bleach activators include the bleach activators, that carry O- and/or N-acyl groups and/or unsubstituted or substituted benzoyl groups. Preference is given to polyacylated alkylenediamines, especially tetraacetylethylenediamine (TAED); acylated glycolurils, especially tetraacetyl glycol urea (TAGU), N,N-diacetyl-N,N-dimethylurea (DDU); sodium-4-benzoyloxy benzene sulphonate (SBOBS); sodium-1-methyl-2-benzoyloxy benzene-4-sulphonate; sodium-4-methyl-3-benzoloxy benzoate; trimethyl ammonium toluyloxy-benzene sulphonate; acylated triazine derivatives, especially 1,5-diacetyl-2,4-dioxohexahydro-1,3,5-triazine (DADHT); compounds of formula (6):

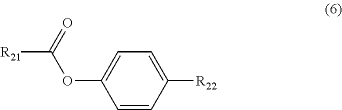

wherein R₂₂ is a sulfonate group, a carboxylic acid group or a carboxylate group, and wherein R₂₁ is linear or branched (C₇-C₁₅)alkyl, especially activators known under the names SNOBS, SLOBS and DOBA; acylated polyhydric alcohols, especially triacetin, ethylene glycol diacetate and 2,5-diacetoxy-2,5-dihydrofuran; and also acetylated sorbitol and mannitol and acylated sugar derivatives, especially pentaacetyiglucose (PAG), sucrose polyacetate (SUPA), pentaacetylfructose, tetraacetylxylose and octaacetyllactose as well as acetylated, optionally N-alkylated glucamine and gluconolactone. It is also possible to use the combinations of conventional bleach activators known from German Patent Application DE-A-44 43 177. Nitrile compounds that form perimine acids with peroxides also come into consideration as bleach activators.

Another useful class of peroxyacid bleach precursors is that of the cationic i.e. quaternary ammonium substituted peroxyacid precursors as disclosed in U.S. Pat. Nos. 4,751,015 and 4,397,757, in EP-A0284292 and EP-A-331,229. Examples of peroxyacid bleach precursors of this class are: 2-(N,N,N-trimethyl ammonium) ethyl sodium-4-sulphonphenyl carbonate chloride—(SPCC), N-octyl,N,N-dimehyl-N₁₀-carbophenoxy decyl ammonium chloride—(ODC), 3-(N,N,N-trimethyl ammonium) propyl sodium-4-sulphophenyl carboxylate and N,N,N-trimethyl ammonium toluyloxy benzene sulphonate.

A further special class of bleach precursors is formed by the cationic nitriles as disclosed in EP-A-303,520, WO 96/40661 and in European Patent Specification No.'s 458,396, 790244 and 464,880. These cationic nitriles also known as nitril quats have the formula

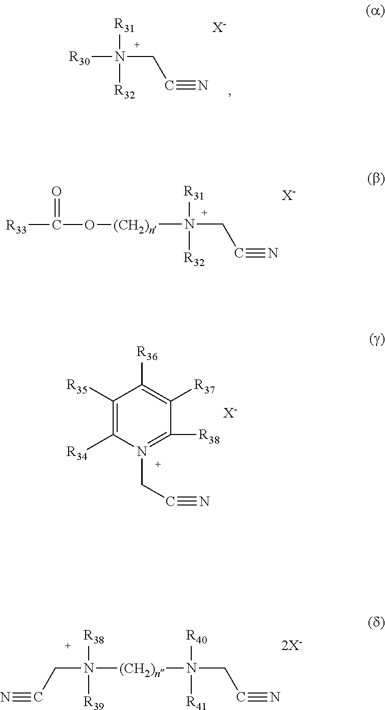

wherein
R₃₀ is a C₁-C₂₄alkyl; a C₁-C₂₄alkenyl; an alkaryl having a C₁-C₂₄alkyl; a substituted C₁-C₂₄alkyl; a substituted C₁-C₂₄alkenyl; a substituted aryl,
R₃₁ and R₃₂ are each independently a C₁-C₃alkyl; hydroxyalkyl having 1 to 3 carbon atoms, —(C₂H₄O)ₙH, n being 1 to 6; —CH₂—CN
R₃₃ is a C₁-C₂₀alkyl; a C₁-C₂₀alkenyl; a substituted C₁-C₂₀alkyl; a substituted C₁-C₂₀alkenyl; an alkaryl having a C₁-C₂₄alkyl and at least one other substituent,
R₃₄, R₃₅, R₃₆, R₃₇ and R₃₈ are each independently hydrogen, a C₁-C₁₀alkyl, a C₁-C₁₀alkenyl, a substituted C₁-C₁₀alkyl, a substituted C₁-C₁₀alkenyl, carboxyl, sulfonyl or cyano
R₃₈, R₃₉, R₄₉ and R₄₁ are each independently a C₁-C₆alkyl,
n′ is an integer from 1 to 3,
n″ is an integer from 1 to 16, and
X is an anion.

Other nitril quats have the following formula

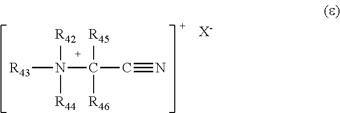

wherein
R₄₂ and R₄₃ form, together with the nitrogen atom to which they are bonded, a ring comprising 4 to 6 carbon atoms, this ring may also be substituted by C₁-C₅-alkyl, C₁-C₅-alkoxy, C₁-C₅-alkanoyl, phenyl, amino, ammonium, cyano, cyanamino or chloro and 1 or 2 carbon atom(s) of this ring may also be substituted by a nitrogen atom, by a oxygen atom, by a N—R₄₇-group and/or by a R₄₄—N—R₄₇-group, wherein R₄₇ is hydrogen, C₁-C₅-alkyl, C₂-C₅-alkenyl, C₂-C₅-alkinyl, phenyl, C₇-C₉-aralkyl,
C₅-C₇-cycloalkyl, C₁-C₅-alkanoyl, cyanomethyl or cyano,
R₄₄ is C₁-C₂₄—, preferably C₁-C₄-alkyl; C₂-C₂₄-alkenyl, preferably C₂-C₄-alkenyl, cyanomethyl or C₁-C₄-alkoxy-C₁-C₄-alkyl,
R₄₅ and R₄₈ are independently from each other hydrogen; C₁-C₄-alkyl; C₁-C₄-alkenyl; C₁-C₄-alkoxy-C₁-C₄-alkyl; phenyl or C₁-C₃-alkylphenyl, preferably hydrogen, methyl or phenyl, whereby preferably the moiety R₄₅ signifies hydrogen, if R₄₈ is not hydrogen, and X⁻ is an anion.

Suitable examples of nitril quats of formula (ε) are

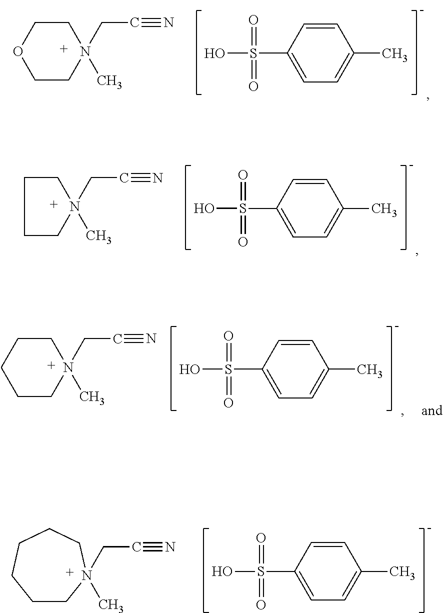

Other nitrile quats have the formula

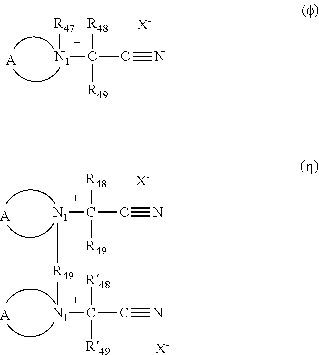

wherein
A is a saturated ring formed by a plurality of atoms in addition to the N₁ atom, the saturated ring atoms to include at least one carbon atom and at least one heteroatom in addition to the N₁ atom, the said one heteroatom selected from the group consisting of O, S and N atoms, the substituent R₄₇ bound to the N₁ atom of the Formula (φ) structure is (a) a C₁-C₈-alkyl or alkoxylated alkyl where the alkoxy is C₂₋₄, (b) a C₄-C₂₄cycloalkyl, (c) a C₇-C₂₄alkaryl, (d) a repeating or nonrepeating alkoxy or alkoxylated alcohol, where the alkoxy unit is C₂-4, or (e) —CR₅₀R₅₁—C≡N where R₅₀ and R₅₁ are each H, a C₁-C₂₄alkyl, cycloalkyl, or alkaryl, or a repeating or nonrepeating alkoxyl or alkoxylated alcohol where the alkoxy unit is C₂-C₄, in Formula (φ) at least one of the R₄₈ and R₄₉ substituents is H and the other of R₄₈ and R₄₉ is H, a C₁-C₂₄alkyl, cycloalkyl, or alkaryl, or a repeating or nonrepeating alkoxyl or alkoxylated alcohol where the alkoxy unit is C₂₋₄, and Y is at least one counterion.

The precursors may be used in an amount of up to 12 wt-%, preferably from 2-10 wt-% based on the total weight of the composition.

It is also possible to use further bleach catalysts, which are commonly known, for example transition metal complexes as disclosed in EP 1194514, EP 1383857 or WO04/007657.

The compositions may comprise, in addition one or more optical brighteners, for example from the classes bis-triazinylamino-stilbenedisulfonic acid, bis-triazolyl-stilbenedisulfonic acid, bis-styryl-biphenyl or bis-benzofuranylbiphenyl, a bis-benzoxalyl derivative, bisbenzimidazolyi derivative or coumarin derivative or a pyrazoline derivative.

The compositions may furthermore comprise one or more further additives. Such additives are, for example, dirt-suspending agents, for example sodium carboxymethylcellulose; pH regulators, for example alkali metal or alkaline earth metal silicates; foam regulators, for example soap; salts for adjusting the spray drying and the granulating properties, for example sodium sulfate; perfumes; and also, if appropriate, antistatics and softening agents such as, for example, smectite; bleaching agents; pigments; and/or toning agents. These constituents should especially be stable to any bleaching agent employed.

Furthermore, the detergent may optionally also comprise enzymes. Enzymes can be added for the purpose of stain removal. The enzymes usually improve the action on stains caused by protein or starch, such as, for example, blood, milk, grass or fruit juices. Preferred enzymes are cellulases and proteases, especially proteases. Cellulases are enzymes that react with cellulose and its derivatives and hydrolyse them to form glucose, cellobiose and cellooligosaccharides. Cellulases remove dirt and, in addition, have the effect of enhancing the soft handle of the fabric.

Examples of customary enzymes include, but are by no means limited to, the following:

proteases as described in U.S. Pat. No. 6,242,405, column 14, lines 21 to 32;
lipases as described in U.S. Pat. No. 6,242,405, column 14, lines 33 to 46;
amylases as described in U.S. Pat. No. 6,242,405, column 14, lines 47 to 56; and
cellulases as described in U.S. Pat. No. 6,242,405, column 14, lines 57 to 64.
Commercially available detergent proteases, such as Alcalase®, Esperase®, Everlase®, Savinase®, Kannase® and Durazyme, are sold e.g. by NOVOZYMES A/S.
Commercially available detergent amylases, such as Termamyl®, Duramyl®, Stainzyme®, Natalase®, Ban® and Fungamyl®, are sold e.g. by NOVOZYMES A/S.
Commercially available detergent ellulases, such as Celluzyme®, Carezyme® and Endolase®, are sold e.g. by NOVOZYMES A/S.
Commercially available detergent lipases, such as Lipolase®, Lipolase Ultra® and Lipoprime®, are sold e.g. by NOVOZYMES A/S.
Suitable mannanases, such as Mannanaway®, are sold by NOVOZYMES A/S.

When present, lipases comprise from about 0.001 wt-% to about 0.01 wt-% of the instant compositions and are optionally combined with from about 1 wt-% to about 5 wt-% of a surfactant having limesoap-dispersing properties, such as an alkyldimethylamine N-oxide or a sulfobetaine. Suitable lipases for use herein include those of bacterial, animal and fungal origin, including those from chemically or genetically modified mutants.

When incorporating lipases into the instant compositions, their stability and effectiveness may in certain instances be enhanced by combining them with small amounts (e.g., less than 0.5 wt-% of the composition) of oily but non-hydrolyzing materials.

The enzymes, when used, may be present in a total amount of from 0.01 to 5 wt-%, especially from 0.05 to 5 wt-% and more especially from 0.1 to 4 wt-%, based on the total weight of the detergent formulation.

Further preferred additives to the compositions according to the invention are dye-fixing agents and/or polymers which, during the washing of textiles, prevent staining caused by dyes in the washing liquor that have been released from the textiles under the washing conditions. Such polymers are preferably polyvinylpyrrolidones, polyvinylimidazoles or polyvinylpyridine-N-oxides, which may have been modified by the incorporation of anionic or cationic substituents, especially those having a molecular weight in the range of from 5000 to 60 000, more especially from 10 000 to 50 000. Such polymers are usually used in a total amount of from 0.01 to 5 wt-%, especially from 0.05 to 5 wt-%, more especially from 0.1 to 2 wt-%, based on the total weight of the detergent formulation. Preferred polymers are those mentioned in WO-A-02/02865 (see especially page 1, last paragraph and page 2, first paragraph) and those in WO-A-04/05688.

In a specific embodiment of the invention the compounds of formula (Ia) or (Ib) are part of a granule.

The granule comprising
a) from 1-99 wt-%, based on the total weight of the granule, of at least one compound of formula (Ia) or (Ib) as defined above,
b) from 1-99 wt-%, based on the total weight of the granule, of at least one binder,
c) from 0-20 wt-%, based on the total weight of the granule, of at least one encapsulating material,
d) from 0-20 wt-%, based on the total weight of the granule, of at least one further additive and
e) from 0-20 wt-% based on the total weight of the granule, of water, the components adding to a total of 100%.

As binder (b) there come into consideration water-soluble, dispersible or water-emulsifiable anionic dispersants, non-ionic dispersants, polymers and waxes.

The anionic dispersants used are, for example, commercially available water-soluble anionic dispersants for dyes, pigments etc.

The following products, especially, come into consideration: condensation products of aromatic sulfonic acids and formaldehyde, condensation products of aromatic sulfonic acids with unsubstituted or chlorinated diphenyls or diphenyl oxides and optionally formaldehyde, (mono-/di-)-alkylnaphthalenesulfonates, sodium salts of polymerised organic sulfonic acids, sodium salts of polymerised alkylnaphthalenesulfonic acids, sodium salts of polymerised alkylbenzenesulfonic acids, alkylarylsulfonates, sodium salts of alkyl polyglycol ether sulfates, polyalkylated polynuclear arylsulfonates, methylene-linked condensation products of arylsulfonic acids and hydroxyarylsulfonic acids, sodium salts of dialkylsulfosuccinic acid, sodium salts of alkyl diglycol ether sulfates, sodium salts of polynaphthalenemethanesulfonates, lignosulfonates or oxylignosulfonates and heterocyclic polysulfonic acids.

Especially suitable anionic dispersants are condensation products of naphthalenesulfonic acids with formaldehyde, sodium salts of polymerised organic sulfonic acids, (mono-/di-)-alkylnaphthalenesulfonates, polyalkylated polynuclear arylsulfonates, sodium salts of polymerised alkylbenzenesulfonic acid, lignosulfonates, oxylignosulfonates and condensation products of naphthalenesuifonic acid with a polychloromethyldiphenyl.

Water-soluble polymers that come into consideration are, for example, polyethylene glycols, copolymers of ethylene oxide with propylene oxide, gelatin, polyacrylates, polymethacrylates, polyvinylpyrrolidones, vinylpyrrolidones, vinyl acetates, polyvinylimidazoles, polyvinylpyridine-N-oxides, copolymers of vinylpyrrolidone with longchain α-olefins, copolymers of vinylpyrrolidone with vinylimidazole, poly(vinylpyrrolidone/dimethylaminoethyl methacrylates), copolymers of vinylpyrrolidone/dimethylaminopropyl methacrylamides, copolymers of vinylpyrrolidone/dimethylaminopropyl acrylamides, quaternised copolymers of vinylpyrrolidones and dimethylaminoethyl methacrylates, terpolymers of vinylcaprolactam/vinylpyrrolidone/dimethylaminoethyl methacrylates, copolymers of vinylpyrrolidone and methacrylamidopropyl-trimethylammonium chloride, terpolymers of caprolactam/vinylpyrrolidone/dimethylaminoethyl methacrylates, copolymers of styrene and acrylic acid, polycarboxylic acids, polyacrylamides, carboxymethyl cellulose, hydroxymethyl cellulose, polyvinyl alcohols, polyvinyl acetate, hydrolysed polyvinyl acetate, copolymers of ethyl acrylate with methacrylate and methacrylic acid, copolymers of maleic acid with unsaturated hydrocarbons, and also mixed polymerisation products of the mentioned polymers.

Of those organic polymers, special preference is given to polyethylene glycols, carboxymethyl cellulose, polyacrylamides, polyvinyl alcohols, polyvinylpyrrolidones, gelatin, hydrolysed polyvinyl acetates, copolymers of vinylpyrrolidone and vinyl acetate, and also polyacrylates, copolymers of ethyl acrylate with methacryiate and methacrylic acid, and polymethacrylates.

Suitable water-emulsifiable or water-dispersible binders also include paraffin waxes.

Encapsulating materials (c) include especially water-soluble and water-dispersible polymers and waxes. Of those materials, preference is given to polyethylene glycols, polyamides, polyacrylamides, polyvinyl alcohols, polyvinylpyrrolidones, gelatin, hydrolysed polyvinyl acetates, copolymers of vinylpyrrolidone and vinyl acetate, and also polyacrylates, paraffins, fatty acids, copolymers of ethyl acrylate with methacrylate and methacrylic acid, and polymethacrylates.

Further additives (d) that come into consideration are, for example, wetting agents, dust removers, water-insoluble or water-soluble dyes or pigments, and also dissolution accelerators, optical brighteners and sequestering agents.

The preparation of the granules according to the invention is carried out, for example, starting from:
a) a solution or suspension with a subsequent drying/shaping step or
b) a suspension of the active ingredient in a melt with subsequent shaping and solidification.

Such processes are well known to those skilled in the art.

In another embodiment, said composition is liquid or gel-like. Liquid in accordance with the present invention means a viscosity of less than 500 mPas at room temperature and gel-like in accordance with the present invention means viscous but still pourable, i.e. a viscosity of less than 10,000 mPas at room temperature, preferably a viscosity between 500 and 10,000 mPas at room temperature. The viscosity can be determined with Brookfield according to DIN ISO 2555:2000-01 (LVT spindle, RT).

Another aspect of the invention is a composition in liquid form comprising
(a) 0.01-95 wt-%, preferably 1-80 wt-%, more preferably 5-70 wt-% of a phthalocyanine compound of formula (Ia) or (Ib) as defined hereinbefore, based on the total weight of the liquid formulation,
(b) 5-99.99 wt-%, preferably 20-99 wt-%, more preferably 30-95 wt-%, based on the total weight of the liquid formulation, of at least one solvent
(c) 0-30 wt-% of an anionic or non-ionic surfactant, based on the total weight of the liquid formulation and
(d) 0-10 wt-%, preferably 0-5 wt-%, more preferably 0-2 wt-%, based on the total weight of the liquid formulation, of at least one further additive, the components adding to a total of 100%.

As solvents, polar solvents are preferred. Especially preferred are C₁-C₄-alcohols or water or mixtures thereof.

Due to their good water solubility the incorporation of the compounds of formulae (Ia) and (Ib) is easily possible.

The excellent levelling properties of the compounds of formulae (Ia) and (Ib) allow in many cases directly on the fabric a (pre)treatment with the liquid formulation. Usually no spotting is observed.

Examples for anionic and non-ionic surfactants have already been given.

If appropriate, the liquid formulation according to the invention can further comprise optional additives; examples are preservatives or mixtures of preservatives, such as chloroacetamide, triazine derivates, benzoisothiazolines, 2-methyl-2H-isothiazol-3on, 2-octyl-2H-isothiazol-3on, 2-brom-2-nitropropan-1,3-diol or aqueous formaldehyde solution; Mg/Al silicates or mixtures of Mg/AI silicates, such as bentonite, montmorillonite, zeolites or highly disperse silicic acids; odour improvers and perfuming agent or mixtures thereof; antifoam agents or mixtures thereof; builders or mixtures thereof; protective colloids or mixtures thereof; stabilizers or mixtures thereof; sequestering agents and antifreeze agents or mixtures thereof, such as propylene glycol.

Below an example is given for a liquid composition to which the compounds of formulae (Ia) and (Ib) may be added.

| | |
|---|---|
| Linear alkyl benzene sulfonic acid, | 5% |
| Non-ionic surfactant | 5.5% |
| 1,2 Propyleneglycol | 6% |
| Ethanol | 2% |
| Soap | 2.5% |
| Ether sulfate | 5% |
| Water | to 100% |

All percentages are percent by weight.

The above described detergent, cleaning, washing or bleaching composition, the granule or the liquid composition are preferably used for the treatment of a textile material.

The washing or cleaning compositions are usually formulated that the washing liquor has a pH value of about 6.5-11, preferably 7.5-11 during the whole washing procedure. The liquor ratio in the washing process is usually 1:4 to 1:40, preferably 1:4 to 1:30.

The washing procedure is usually done in a washing machine.

There are various types of washing machines, for example:
top-loader-washing machines with a verticle rotating axis; these machines, which have usually a capacity of about 45 to 83 litres, are used for washing processes at temperatures of 10-50° C. and washing cycles of about 10-60 minutes. Such types of washing machines are often used in the USA;
front-loader-washing machine with a horizontal rotating axis; these machines, which have usually a capacity of about 8 to 15 litres, are used for washing processes at temperatures of 30-95° C. and washing cycles of about 10-60 minutes. Such types of washing machines are often used in Europe;
top-loader-washing machines with a verticle rotating axis; these machines, which have usually a capacity of about 26 to 52 litres, are used for washing processes at temperatures of 5-25° C. and washing cycles of about 8-15 minutes. Such types of washing machines are often used in Japan.

The composition according to the invention can also be used in a soaking process, where the stained textiles are left for 0.1-24 hours in a solution or suspension of the detergent and/or bleaching laundry additive without agitation. Soaking can take place for example in a bucket or in a washing machine. Usually the textiles are washed and/or rinsed after the soaking process.

As described above, the detergent formulations can take a variety of physical forms such as, for example, powder granules, tablets (tabs), gel and liquid. Examples thereof include, inter alia, conventional high-performance detergent powders, supercompact high-performance detergent powders and tabs. One important physical form is the so-called concentrated granular form, which is added to a washing machine.

A further aspect of the invention is a process for removing stains and soil from textile materials comprising the steps:
a) treating a textile material with a detergent, cleaning, washing or bleaching composition comprising at least one compound of formula (Ia) or (Ib) as described above;
b) exposing the treated textile material to actinic radiation;
c) rinsing or washing the textile material,

Treating a textile material with a detergent, cleaning, washing or bleaching composition may be carried out, for example in a conventional washing process either a hand washing process or a machine washing process.

The treatment can, however, also be carried out in a separate process, such as a spraying, soaking, padding or rinsing step followed by exposing the textile material to actinic radiation.

Examples for a detergent, cleaning, washing or bleaching composition have been given above. In a specific embodiment the detergent, cleaning, washing or bleaching composition is a composition as described in claim 5.

In the context of the present invention under actinic radiation there is understood electromagnetic radiation from a natural source, such as sun light or from an artificial source, such as from lamps, being effective in producing an active bleaching species upon irradiating the compounds of formula (Ia) or (Ib).

Any light source—which emits light in an wavelength range [650-800 nm]—may be employed as a radiation source, such as, Tungsten or Halogen lamp, a red or infrared LED, a red or infrared laser (diode), red light emitting OLED and a flash light.

The mentioned light sources can be used also in the process of the present invention. Multi-spectrum lamps can also be used.

Advantageously, the light sources should emit actinic radiation preferably in the maximum absorption range of the β-ethoxylated Zinc and Aluminium phthalocyanines [670-750 nm].

Alternatively the treated textile material is exposed to natural sunlight.

Preferably the actinic radiation comprises radiation with a wavelength from 670 nm to 750 nm.

After the photobleaching step b) a rinsing or washing step is applied to remove the bleached residues from soil or stains.

A further aspect of the invention is an ortho substituted compound of formula IIa and its position isomers

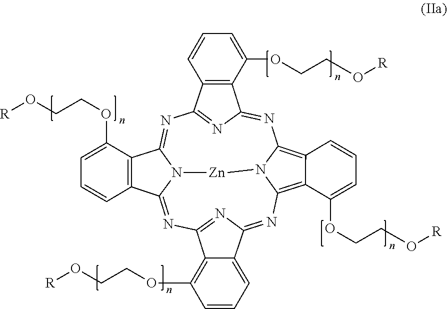

wherein R is H or CH₃ and
n is a number from 7 to 70, preferably from 7 to 40, more preferably from 7 to 25,

The compounds, wherein R is H or CH₃ and n is a number greater than 7 are new and, therefore, also subject of the instant invention.

The definitions and preferences given above apply equally for all aspects of the invention.

The following examples illustrate the invention in detail,

### A) Preparation Examples

The polyalkyleneglycols (n>6) used are technical mixtures with average molecular weight distributions. Only the main component is indicated in the formulae.

All metallated phthalocyanine compounds show position iso ery, only one possible isomer is given.

### Example 1

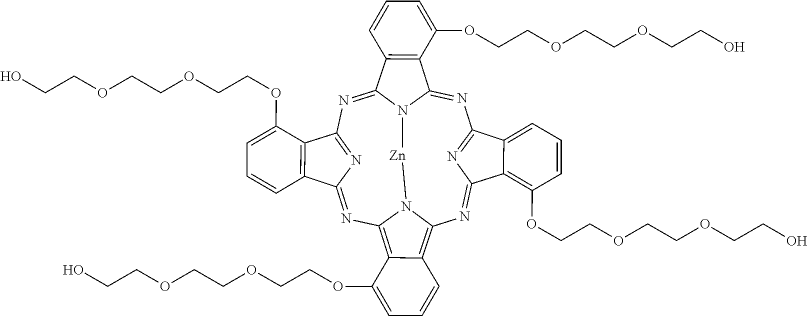

### Synthesis of Intermediate 1a

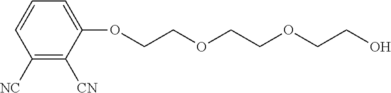 [SMILES: N#Cc1cccc(OCCOCCOCCO)c1C#N]

A solution of 1 g (6 mmol) 3-nitrophthalonitrile, 8.67 g (58 mmol) triethylene glycol and 4.8 g (34 mmol) potassium carbonate in 20 ml of dry DMF is reacted (reaction temperature: 20° C., reaction time 24 hours) and worked-up as described in the general procedure 1). Yield: 1.39 g, red solid.

¹H NMR (CDCl₃): δ=3.6-3.85 (m, 8H, OCH₂), 4.0 and 4.35 (m; each 2H, OCH₂), 7.3-7.4 (m; 2H, Aryl-H); 7.65 (m; Aryl-H) ppm.

### Synthesis of Zinc Phthalocyanine Derivative 1

1.39 g (5 mmol) intermediate 1a, 0.17 g (1.2 mmol) anhydrous zinc chloride and 0.77 g (5.05 mmol) DBU are reacted and worked-up as described in general procedure 2). Yield: 1.53 g, green solid.

UVᵥᵢₛ: λₘₐₓ=703 nm.

MS: C₅₆H₆₄N₈O₁₆Zn²⁺ (1170.56), m/z_{found}=1170 (M⁺, z=1), 586 (M⁺+H⁺, z=2).

### Example 2

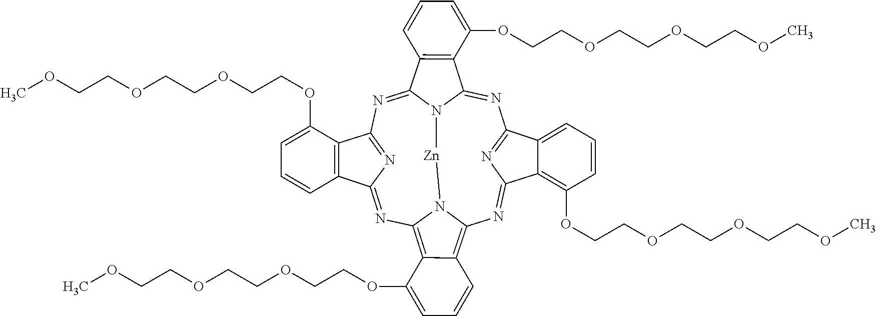

This compound is known [Kobayashi et al., Bull. Chem. Soc. Jpn. 72, 1263 (1999).

### Synthesis of Intermediate 2a

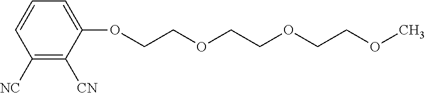 [SMILES: COCCOCCOCCOc1cccc(C#N)c1C#N]

A solution of 4.37 g (25 mmol) 3-nitrophthalonitrile, 6.35 g (38 mmol) triethylene glycol monomethylether and 6.98 g (50 mmol) potassium carbonate in 10 ml of dry DMF is reacted and worked-up as described in the general procedure 1). Yield: 5.6 g, grey solid.

¹H NMR (CDCl₃): δ=3.4 (s; 3H, OMe), 3.56 (m; 2H, OCH₂), 3.67 (m; 4H, OCH₂), 3.75 (m; 2H, OCH₂), 3.95 (m; 2H, OCH₂), 4.32 (m; 2H, OCH₂), 7.35 (m; 2H, Aryl-H); 7.65 (m; 1H, Aryl-H) ppm.

MS: m/z=281 (M−H)⁺

### Synthesis of Zinc Phthalocyanine Derivative 2

Under stirring, 3.48 g (12 mmol) of intermediate 2a and 1.1 g (6.0 mmol) zinc(II)acetate are suspended in 50 ml of N,N-dimethylaminoethanol. During the reaction, nitrogen is passed through the reaction vessel. The reaction solution is heated to 135° C. and stirred at this temperature for 24 hours. When the reaction is complete (TLC control dichloromethane/methanol 10:1), the production mixture is worked-up.

The reaction mixture is cooled down to 20° C. and evaporated to dryness in vacuo. The resulted dark greenish solid is purified twice by column chromatography (dichloromethane/methanol 95:5). Yield: 1.1 g, green solid.

UVᵥᵢₛ: λₘₐₓ=702 nm.

MS: C₆₀H₇₂N₈O₁₆Zn (1226.7), m/z_{found}=1225 (M⁺−H, z=1), 1247 (M⁺+Na).

### Example 3

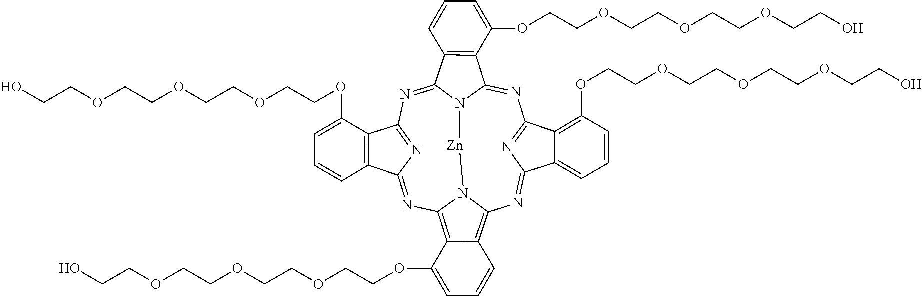

This compound is known [Ahsen et al. Dalton Trans. 40 (2011), 4067)], the reported procedure was slightly modified.

### Synthesis of Intermediate 3a

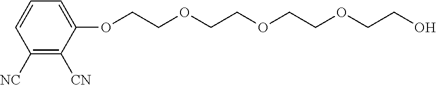 [SMILES: N#Cc1cccc(OCCOCCOCCOCCO)c1C#N]

A solution of 1 g (5.8 mmol) 3-nitrophthalonitrile, 3.9 g (20 mmol) tetraethylene glycol and 4.8 g (34 mmol) potassium carbonate in 40 ml of dry DMF is reacted at 20° C. for 24 hours and worked-up as described in the general procedure 1). Yield: 1.3 g, white slightly yellowish solid.

¹H NMR (CDCl₃): δ=3.6-3.8 (m; 10H, OCH₂), 3.9 and 4.3 (m; each 2H, OCH₂), 7.3-7.4 (m; 2H, Aryl-H); 7.63 (m; Aryl-H) ppm.

MS: m/z=321 (M−H)⁺

### Synthesis of Zinc Phthalocyanine Derivative 3

1.28 g (4.0 mmol) intermediate 3a, 0.14 g (1.0 mmol) zinc chloride and 0.63 g (4.1 mmol) DBU are suspended in 10 ml 1-pentanol. The reaction mixture is reacted and worked-up as described in the general procedure 2).

Yield: 2.4 g, dark green solid. The crude product is purified by column chromatography (solvent mixture: dichloromethane/methanol 10:2) to yield 1.6 g of a green solid.

UVᵥᵢₛ: λₘₐₓ=703 nm.

MS: C₆₄H₈₀N₈O₂₀Zn (1346.), m/z_{found}=1344.4 (M⁺−2H, z=1).

### Example 4

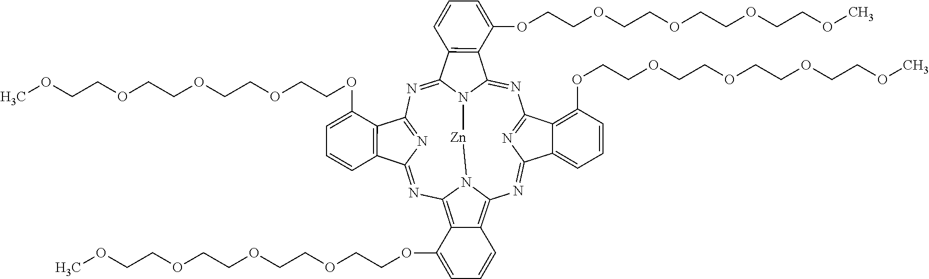

### Synthesis of Intermediate 4a

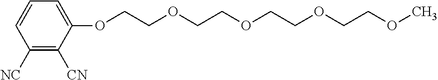 [SMILES: COCCOCCOCCOCCOc1cccc(C#N)c1C#N]

A solution of 2.0 g (11.6 mmol) 3-nitrophthalonitrile, 3.7 g (17.8 mmol) tetraethylene glycol monomethylether and 3.1 g (23 mmol) potassium carbonate in 5 ml of dry DMF is reacted and worked-up as described in the general procedure 1). Yield: 2.8 g, white slightly brownish solid.

¹H NMR (CDCl₃): δ=3.4 (5, 3H, OMe), 3.5-3.7 (m, 12H, OCH₂), 3.9 and 4.35 (m; each 2H, OCH₂), 7.38 (m; 2H, Aryl-H); 7.65 (m; 1H, Aryl-H) ppm.

### Synthesis of Zinc Phthalocyanine Derivative 4

2.7 g (8.1 mmol) intermediate 4a, 0.28 g (2.1 mmol) zinc chloride and 1.23 g (8.1 mmol) DBU are suspended in 20 ml 1-pentanol. The reaction mixture is heated to 130° C. for 24 hours and worked-up as described in the general procedure 2).

Yield: 2.2 g, green solid.

UVᵥᵢₛ: λₘₐₓ=703 nm.

MS: C₆₈H₈₈N₈O₂₀Zn (1402.88), m/z_{found}=1402 (M⁺, z=1), 702 (M⁺, z=2).

### Example 5

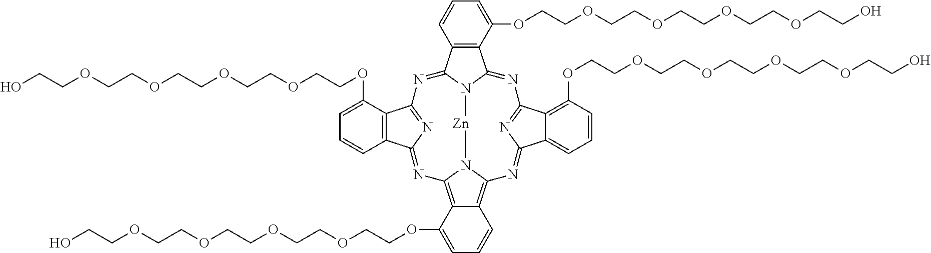

### Synthesis of Intermediate 5a

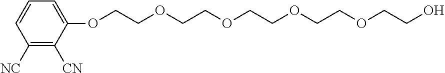 [SMILES: N#Cc1cccc(OCCOCCOCCOCCOCCO)c1C#N]

A solution of 2.0 g (11.6 mmol) 3-nitrophthalonitrile, 9.93 g (40 mmol) of pentaethylene glycol and 9.6 g (69 mmol) potassium carbonate in 45 ml of dry DMF is stirred for 18 hours at 20° C. and worked-up as described in the general procedure 1). Yield: 3.2 g, white slightly brownish solid.

¹H NMR (CDCl₃): δ=3.6-3.8 (m; 16H, OCH₂), 3.95 and 4.3 (m; each 2H, OCH₂), 7.35 (m; 2H, Aryl-H); 7.67 (m; Aryl-H) ppm.

### Synthesis of Zinc Phthalocyanine Derivative 5

3.2 g (8.8 mmol) intermediate 5a, 0.3 g (2.2 mmol) zinc chloride and 1.34 g (813 mmol) DBU are suspended in 20 ml 1-pentanol. The reaction mixture is heated to 130° C. for 12 hours. The reaction mixture is cooled to 0° C. and filtrated. The mother liquor is poured into 100 ml of heptane and worked-up as described in the general procedure 2). Yield: 2.5 g, green solid.

UVᵥᵢₛ: λₘₐₓ=704 nm.

MS: C₇₂H₉₆N₈O₂₄Zn (1522.98), m/z_{found}=1523 (M⁺, z=1), 1524 (M+H).

### Example 6

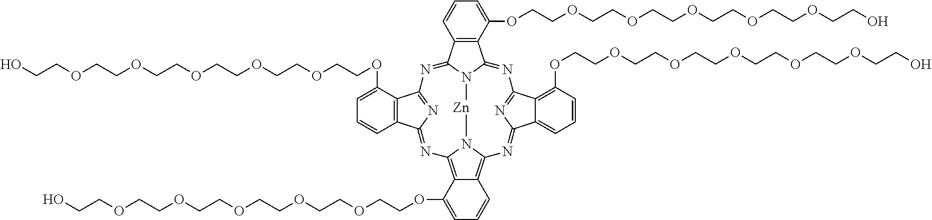

### Synthesis of Intermediate 6a

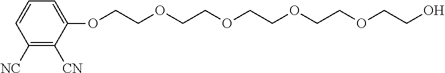 [SMILES: N#Cc1cccc(OCCOCCOCCOCCOCCO)c1C#N]

A solution of 2.0 g (11.6 mmol) 3-nitrophthalonitrile, 11.8 g (40.4 mmol) hexamethylene glycol and 9.58 g (69 mmol) potassium carbonate in 40 ml of dry DMF is stirred for 2 hours at 20° C. The reaction is complete (TLC control with ethyl acetate as solvent). The precipitate is removed filtration and the obtained mother liquor is taken up in 100 ml dichloromethane and extracted three times with 100 ml of water. The organic phase is dried with magnesium sulfate, filtered and evaporated in high vacuo.

¹H NMR (CDCl₃): δ=2.6 (broad s; OH), 3.55-3.75 (m; 20H, OCH₂), 3.9 and 4.3 (m; each 2H, OCH₂), 7.35 (m: 2H, Aryl-H); 7.67 (m; Aryl-H) ppm.

Yield: 4.8 g, white slightly brownish solid.

### Synthesis of Zinc Phthalocyanine Derivative 6

4.7 g (11.51 mmol) intermediate 6a, 0.39 g (2.88 mmol) zinc chloride and 1.75 g (11.51 mmol) DBU are suspended in 20 ml 1-pentanol. The reaction mixture is heated to 130° C. for 12 hours. The reaction mixture is worked-up with heptane and dichloromethane as described in the general procedure 2). Yield: 5.85 g crude product, dark-green oil.

UVᵥᵢₛ: λₘₐₓ=704 nm.

MS: C₈₀H₁₁₂N₈O₂₈Zn (1699.19), m/z_{found}=1699 (M+z=1).

### Example 7

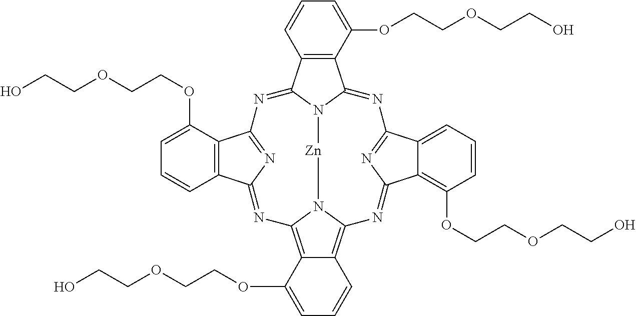

### Synthesis of Intermediate 7a

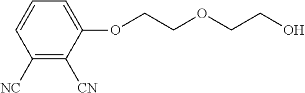 [SMILES: N#Cc1cccc(OCCOCCO)c1C#N]

A solution of 2.0 g (11.6 mmol) 3-nitrophthalonitrile, and 12.6 g (116 mmol) diethylene glycol in 45 ml of dry DMF is cooled to −10° C. Then, 3.19 g (23.1 mmol) potassium carbonate is added. The reaction solution is stirred for 4 hours at −10° C. and then warmed up to 20° C. The obtained reaction solution is filtrated and worked-up as described in the general procedure 1), Yield: 2.0 g, white slightly orange solid.

1H NMR (CDCl₃): δ=2.15 (m; OH), 3.7-3.8 (m; 4H, OCH₂), 3.96 and 4.34 (m, each 2H, OCH₂), 7.35 (m; 2H, Aryl-H); 7.65 (m; Aryl-H) ppm.

### Synthesis of Zinc Phthalocyanine Derivative 7

2 g (8.6 mmol) intermediate 7a, 0.29 g (2.15 mmol) zinc chloride and 1.32 g (8.6 mmol) DBU are suspended in 20 ml 1-pentanol. The reaction mixture is heated to 130° C. for 12 hours and worked-up with heptane and dichloromethane as described in the general procedure 2). Yield: 1.6 g green solid.

UVᵥᵢₛ: λₘₐₓ=702 nm.

MS: C₄₈H₄₈N₈O₁₂Zn (994.35), m/z_{found}=994 (M⁺, z=1), 497 (M⁺, z=2).

### Example 8

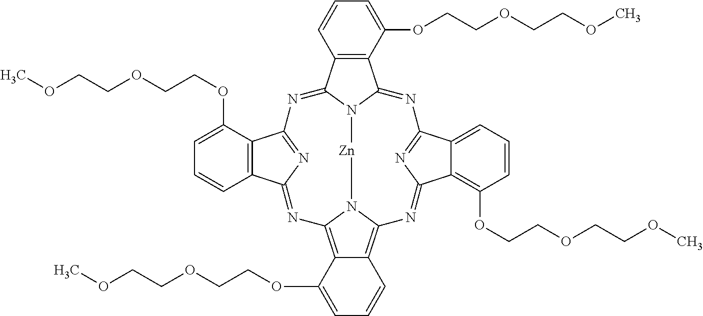

### Synthesis of Intermediate 8a

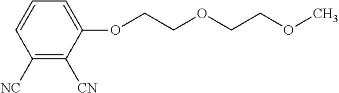 [SMILES: COCCOCCOc1cccc(C#N)c1C#N]

A solution of 2.0 g (11.6 mmol) 3-nitrophthalonitrile, 2.15 g (17.3 mmol) diethylene glycol monomethylether and 3.19 g (23.1 mmol) potassium carbonate in 4 ml of dry DMF is reacted and worked-up as described in the general procedure 1). Yield: 2.7 g, white slightly brownish solid.

¹H NMR (CDCl₃): δ=3.4 (s; OCH₃), 3.60, 3.75, 3.95, 4.34 (m; each 2H. OCH₂), 7.38 (m; 2H, Aryl-H); 7.65 (m; Aryl-H) ppm.

### Synthesis of Zinc Phthalocyanine Derivative 8

2.6 g (10.55 mmol) intermediate 8a, 0.36 g (2.6 mmol) zinc chloride and 1.61 g (10.6 mmol) DBU are suspended in 25 ml 1-pentanol. The reaction mixture is heated to 130° C. for 12 hours. The reaction mixture is worked-up with heptane and dichloromethane as described in the general procedure 2). Yield: 1.2 g green solid.

UVᵥᵢₛ: λₘₐₓ=703 nm.

MS: C₅₂H₅₆N₈O₁₂Zn (1050.46), m/z_{found}=1050, 1051 (M⁺, z=1), 525 (M⁺, z=2).

### Example 9

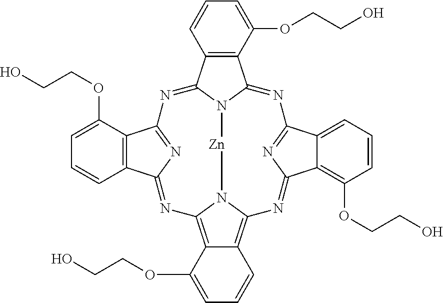

### Synthesis of Intermediate 9a

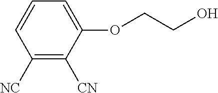 [SMILES: N#Cc1cccc(OCCO)c1C#N]

A solution of 1.0 g (5.8 mmol) 3-nitrophthalonitrile, and 3.7 g (58 mmol) ethylene glycol in 20 ml of dry DMF is cooled to −10° C. Then, 1.6 g (11.6 mmol) potassium carbonate is added. The reaction solution is stirred for 4 hours at −10° C. and then warmed up to 20° C. The obtained reaction solution is filtrated and worked-up as described in the general procedure 1). Yield: 0.73 g, white slightly orange solid.

¹H NMR (CDCl₃): δ=1.66 (broad s; 1H, OH), 4.07 and 4.27 (m; each 2H, OCH₂), 7.29, 7.42 and 7.68 (m; each 1H, Aryl-H) ppm.

### Synthesis of Zinc Phthalocyanine Derivative 9

0.7 g (3.7 mmol) intermediate 9a, 0.13 g (0.95 mmol) zinc chloride and 0.57 g (3.7 mmol) DBU are suspended in 15 ml 1-pentanol. The reaction mixture is heated to 130° C. for 12 hours. The reaction mixture is cooled to 0° C. and some precipitated product (0.33 g) is isolated by filtration. The mother liquor is treated with heptane and dichloromethane as described in the general procedure 2) to give more product (0.6 g). Yield: 0.99 g, green solid.

UVᵥᵢₛ: λₘₐₓ=705 nm.

MS: C₄₀H₃₂N₈O₈Zn (818.14), m/z_{found}=818 (M⁺, z=1), 409 (M⁺, z=2)

### Example 10

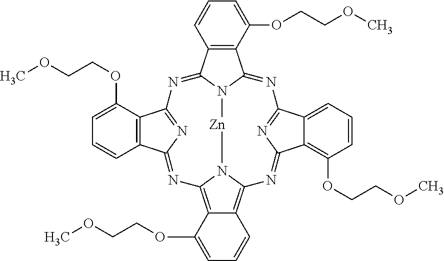

### Synthesis of Intermediate 10a

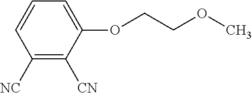

A solution of 2.0 g (11.6 mmol) 3-nitrophthalonitrile, 1.36 g (17.8 mmol) ethylene glycol monomethylether and 3.2 g (23.1 mmol) potassium carbonate in 5 ml of dry DMF is reacted and worked-up as described in the general procedure 1). Yield: 2.17 g, white solid.

¹H NMR (CDCl₃): δ=3.5 (s: OCH₃), 3.85 and 4.34 (m; each 2H, OCH₂), 7.34 (m; 2H, Aryl-H); 7.65 (m; Aryl-H) ppm.

### Synthesis of Zinc Phthalocyanine Derivative 10

2.17 g (10.73 mmol) intermediate 10a, 0.46 g (2.68 mmol) zinc chloride and 2.06 g (10.72 mmol) DBU are suspended in 25 ml 1-pentanol. The reaction mixture is heated to 130° C. for 12 hours. Then reaction mixture is cooled to 20° C. and the product is filtered off. Yield: 1.7 g, blue-green solid.

UVᵥᵢₛ: λₘₐₓ=702 nm.

MS: C₄₄H₄₀N₈O₈Zn (874.25), m/z_{found}=874 (M⁺, z=1).

### Example 11

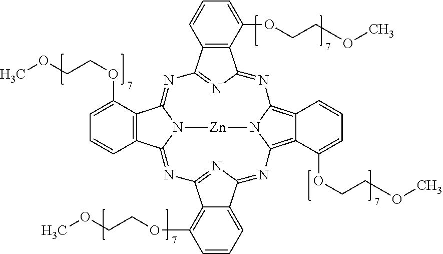

### Synthesis of Intermediate 11a

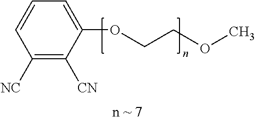

A solution of 2.0 g (11.6 mmol) 3-nitrophthalonitrile, 14.6 g (40.4 mmol) Pluriol A 350 E and 9.58 g (69.3 mmol) potassium carbonate in 47 ml of dry DMF is stirred at 20° C. for 22 hours. The work-up is done as described in the general procedure 1). Yield: 7.33 g crude product, clear yellowish liquid.

¹H NMR (CDCl₃): δ=3.4 (s; OCH₃), 3.55-3.75 (m; numerous Pluriol OCH₂), 3.93 and 4.32 (m; each 2H, OCH₂), 7.34 (m; 2H, Aryl-H); 7.64 (m; Aryl-H) ppm.

### Synthesis of Zinc Phthalocyanine Derivative 11

7.3 g (5.3 g (11.57 mmol) active intermediate 11a, 0.39 g (2.89 mmol) zinc chloride and 1.75 g (11.5 mmol) DBU are suspended in 20 ml 1-pentanol. The reaction mixture is heated to 137° C. for 12 hours. Afterwards, the reaction mixture is cooled to 0° C. and the resulting product mixture is poured into 200 ml heptane. Further work-up is done according to the general procedure 2).

Yield: 6.8 g dark-green oil.

UVᵥᵢₛ: λₘₐₓ=704 nm.

### Example 12

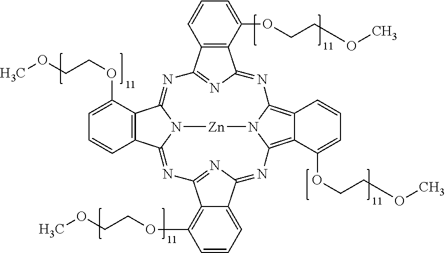

### Synthesis of Intermediate 12a

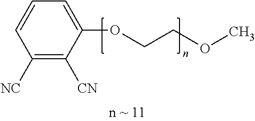

A solution of 1.0 g (5.8 mmol) 3-nitrophthalonitrile, 11.91 g (40.4 mmol) Pluriol A 500 E and 4.79 g (35 mmol) potassium carbonate in 21 ml of dry DMF is stirred at 20° C. for 22 hours. The work-up is done as described in the general procedure 1), Yield: 6.55 g crude product, clear yellowish liquid.

¹H NMR (CDCl₃): δ=3.38 (s; OCH₃), 3.5-3.8 (m; numerous Pluriol OCH₂), 3.93 and 4.3 (m; each 2H, OCH₂), 7.35 (m; 2H, Aryl-H); 7.65 (m; Aryl-H)

### Synthesis of Zinc Phthalocyanine Derivative 12

6.55 g crude intermediate 12 a (3.71 g active, 5.77 mmol), 0.2 g (1.44 mmol) zinc chloride and 0.88 g (5.77 mmol) DBU are suspended in 20 ml 1-pentanol. The reaction mixture is heated to 135° C. for 12 hours. Then reaction mixture is cooled to 0° C. and worked-up according to the general procedure 2).

Yield: 4.13 g, dark-green oil.

UVᵥᵢₛ: λₘₐₓ=704 nm.

### Example 13

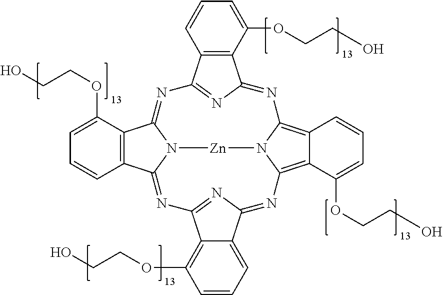

### Synthesis of Intermediate 13a

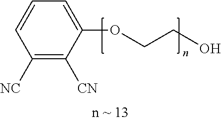

A solution of 1 g (5.77 mmol) 3-nitrophthalonitrile, 3.93 g (6.3 mmol) Pluriol E 600 and 4.79 g (34.7 mmol) potassium carbonate in 21 ml of dry DMF is stirred at 20° C. for 22 hours. The work-up is done as described in the general procedure 1). Yield: 3.32 g crude product, yellowish liquid.

¹H NMR (CDCl₃): δ=2.35 (s; OH), 3.6-3.77 (m; numerous Pluriol OCH₂), 3.94 and 4.3 (m; each 2H, OCH₂), 7.33 (m; 2H, Aryl-H); 7.65 (m; Aryl-H) ppm.

### Synthesis of Zinc Phthalocyanine Derivative 13

3.2 g (4.4 mmol) intermediate 13a, 0.15 g (1.1 mmol) zinc chloride and 0.67 g (4.4 mmol) DBU are suspended in 20 ml 1-pentanol. The reaction mixture is heated to 135° C. for 12 hours. Then reaction mixture is cooled to 0° C. and worked-up according to the general procedure 2).

Yield: 3.9 g, dark-green oil.

UVᵥᵢₛ: λₘₐₓ=704 nm.

### Example 14

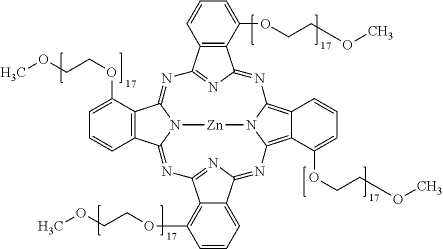

### Synthesis of Intermediate 14a

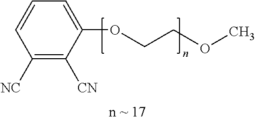

A solution of 1 g (5.77 mmol) 3-nitrophthalonitrile, 4.98 g (6.35 mmol) Pluriol A 760 E and 4.79 g (34.7 mmol) potassium carbonate in 21 ml of dry DMF is stirred at 20° C. for 96 hours. The work-up is done as described in the general procedure 1). Yield: 4.1 g crude product, yellowish solid.

¹H NMR (CDCl₃): =3.37 (s; OCH₃), 3.6-3.7 (m; numerous Pluriol OCH₂), 3.6; 3.8; 3.92; 4.32 (m; each 2H, OCH₂), 7.35 (m; 2H, Aryl-H); 7.65 (m; Aryl-H) ppm.

### Synthesis of Zinc Phthalocyanine Derivative 14

4.19 g (47 mmol) intermediate 14a, 0.15 g (1.17 mmol) zinc chloride and 0.67 g (4.4 mmol) DBU are suspended in 20 ml 1-pentanol. The reaction mixture is heated to 135° C. for 12 hours. Then reaction mixture is cooled to 0° C. and worked-up according to the general procedure 2).

Yield: 2.21 g, dark-green oil.

UVᵥᵢₛ: λₘₐₓ=704 nm.

### Example 15

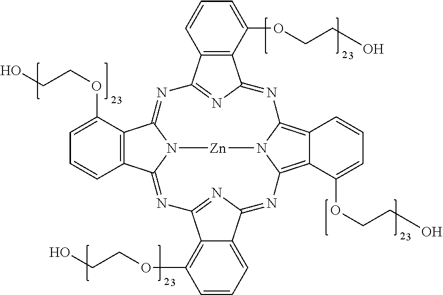

### Synthesis of Intermediate 15a

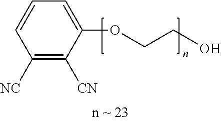

A solution of 1 g (5.77 mmol) 3-nitrophthalonitrile, 23.8 g (23.1 mmol) Pluriol E 1000 and 4.79 g (34.7 mmol) potassium carbonate in 21 ml of dry DMF is stirred at 20° C. for 24 hours. The work-up is done as described in the general procedure 1). Yield: 12.5 g crude product, yellow solid.

¹H NMR (CDCl₃): δ=2.25 (s; OCH₃), 3.55-3.8 (m; numerous Pluriol OCH₂), 3.94 and 4.31 (m; each 2H. OCH₂), 7.36 (m; 2H, Aryl-H); 7.66 (m; Aryl-H) ppm.

### Synthesis of Zinc Phthalocyanine Derivative 15

12.5 g crude (content active 6.5 g, 5.77 mmol) intermediate 15a, 0.2 g (1.4 mmol) zinc chloride and 0.88 g (5.77 mmol) DBU are suspended in 20 ml 1-pentanol. The reaction mixture is heated to 135° C. for 12 hours. Then reaction mixture is cooled to 0° C. and worked-up according to the general procedure 2).

Yield: 12.2 g crude product, dark-green oil.

UVᵥᵢₛ: λₘₐₓ=704 nm.

### Example 16

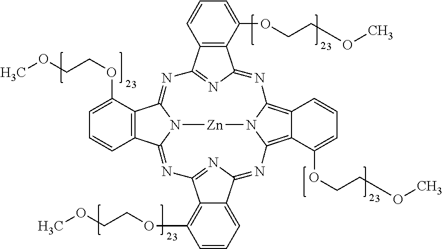

### Synthesis of Intermediate 16a

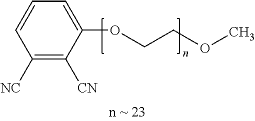

A solution of 1 g (5.77 mmol) 3-nitrophthalonitrile, 6.68 g (6.35 mmol) Pluriol A 1020 E and 4.79 g (34.7 mmol) potassium carbonate in 21 ml of dry DMF is stirred at 20° C. for 3 days. The workup is done as described in the general procedure 1). Yield: 7.15 g crude product, yellow solid.

¹H NMR (CDCl₃): δ=3.36 (s; OCH₃), 3.5-3.7 (m; numerous Pluriol OCH₂), 3.52, 3.75, 3.9, 4.3 (m; each 2H, OCH₂), 7.35 (m; 2H, Aryl-H); 7.64 (m; Aryl-H)

### Synthesis of Zinc Phthalocyanine Derivative 16

7.15 g crude (content active 6.73 g, 5.87 mmol) intermediate 16a, 0.2 g (1.47 mmol) zinc chloride and 0.88 g (5.86 mmol) DBU are suspended in 20 ml 1-pentanol. The reaction mixture is heated to 135° C. for 12 hours. Then reaction mixture is cooled to 0° C. and worked-up according to the general procedure 2).

Yield: 6.2 g crude product, dark-green oil.

UVᵥᵢₛ: λₘₐₓ=703 nm.

### Example 17

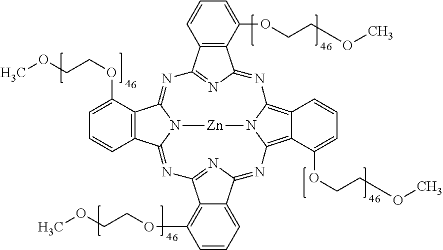

### Synthesis of Intermediate 17a

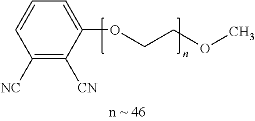

A solution of 1 g (5.77 mmol) 3-nitrophthalonitrile, 1317 g (6.35 mmol) Pluriol A 2010 E and 4.79 g (34.7 mmol) potassium carbonate in 21 ml of dry DMF is stirred at 20° C. for 6 days. The work-up is done as described in the general procedure 1). Yield: 13.13 g crude product, yellow solid.

¹H NMR (CDCl₃): δ=3.39 (s; OCH₃), 3.5-3.85 (m; numerous Pluriol OCH₂), 3.92 and 4.3 (m; each 2H, OCH₂), 7.37 (m; 2H, Aryl-H); 7.65 (m; Aryl-H) ppm.

### Synthesis of Zinc Phthalocyanine Derivative 17

13.13 g crude (content active 12.54 g, 5.87 mmol) intermediate 17a, 0.2 g (1.47 mmol) zinc chloride and 0.89 g (5.87 mmol) DBU are suspended in 20 ml 1-pentanol. The reaction mixture is heated to 135° C. for 12 hours. Then reaction mixture is cooled to 20° C. The obtained solid is heated to 60° C. and poured into 100 mi heptane. The crude product is decanted and taken up with 50 ml dichloromethane and evaporated in vacuo.

Yield: 12.0 g, dark-green oil.

UVᵥᵢₛ: λₘₐₓ=704 nm.

### Example 18

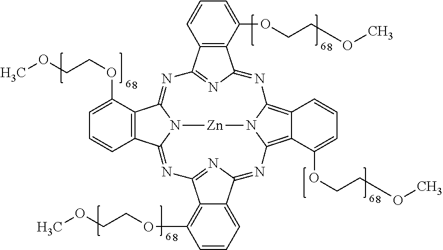

### Synthesis of Intermediate 18a

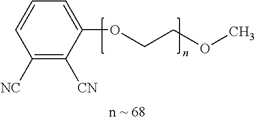

A solution of 1 g (5.77 mmol) 3-nitrophthalonitrile, 19.72 g (6.5 mmol) Pluriol A 3010 E and 4.79 g (34.7 mmol) potassium carbonate in 42 ml of dry DMF is stirred at 20° C. for 7 days. The work-up is done as described in the general procedure 1). Yield: 18.9 g crude product, white solid.

¹H NMR (CDCl₃): δ=3.40 (s; OCH₃), 3.4-3.8 (m; numerous Pluriol OCH₂), 3.88 and 4.29 (m; each 2H, OCH₂), 7.35 (m; 2H, Aryl-H); 7.61 (m; Aryl-H) ppm.

### Synthesis of Zinc Phthalocyanine Derivative 18

18.9 g crude (content active 18.4 g, 5.87 mmol) intermediate 18a, 0.2 g (1.47 mmol) zinc chloride and 0.89 g (5.87 mmol) DBU are suspended in 20 ml 1-pentanol. The reaction mixture is heated to 135° C. for 12 hours. Then reaction mixture is cooled to 20° C. The crude solid reaction mixture is worked-up according to the procedure described in Example 17.

Yield: 18 g crude product, dark-green oil.

### Example 19

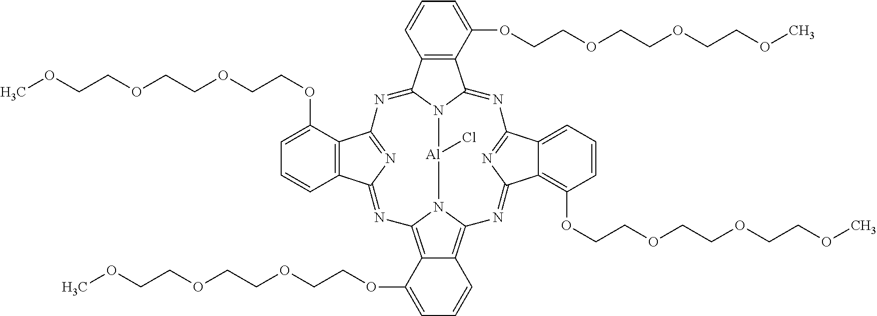

2.9 g (10 mmol) of intermediate phthalonitrile derivative 2a from example 2 are suspended in 10 ml 1-pentanol. Under stirring and under nitrogen atmosphere, 1.52 g (1.46 ml, 10 mmol) DBU and 0.4 g (3 mmol) anhydrous aluminium trichloride are added. The reaction mixture is then refluxed for 24 hours, cooled down to 20° C. and worked-up as described in procedure 2).

Yield: 2 g crude product, dark-green solid.

UVᵥᵢₛ: λₘₐₓ=670 nm.

### Example 20

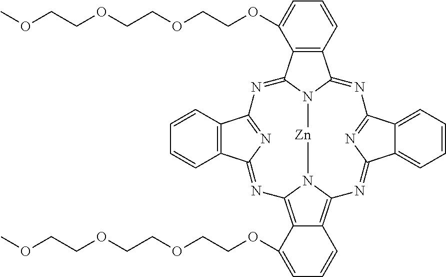

0.7 g (2.4 mmol) of intermediate 2a from example 2, 0.31 g (2.4 mmol) phthalonitrile, 0.16 g (1.2 mmol) and 0.73 g (4.8 mmol) DBU are suspended in 12 ml 1-pentanol. The stirred reaction mixture is heated to 135° C. and kept at this temperature for 12 hours. The reaction mixture is cooled down to 20° C. The formed product is filtered off and dried in high vacuo.

Yield: 0.7 g bluish-green solid.

UVᵥᵢₛ: λₘₐₓ=686 nm.

### Application Examples

To evaluate photobleaching properties commercial fabric stains (Tea CFT C-BC03, Tea Empa167, Coffee WFK 10K, Coffee CET C-BC02, Red Wine Empa114) were washed in a Linitest with detergent in presence and absence of the photocatalyst followed by subse-subsequent exposure to light. Washing conditions were: 3fold wash, 0.2 g detergent ECE77 w/o optical brightener, liquor ratio 13:1 (100 mL liquor), 15 min, 30° C., 10.0 g ballast cotton renforce 1-3005, 2.5 g stained fabric. The test compounds were added as diluted liquid to the wash liquor. After each wash cycle the fabrics were rinsed for 5 min at 30° C. with 200 mL water, centrifuged and ironed. Subsequently, for each cycle the fabrics were then placed into a porcelain dish and exposed in the wet state for 120 min to a 100 W tungsten lamp (inhouse manufactured radiation cabinet with controlled light intensity of ˜17000Lux, measured with a Voltcraft MS1300 digital lux meter at the position of the fabric). The effect of the photocatalyst could either be directly evaluated by visual comparison of swatches washed in presence and absence of the respective test compound (both swatches exposed to similar illumination conditions) or by referring to the respective reflection spectra of the fabrics. The intensity of the stain was typically reduced upon increasing light exposure time and cycle number. The fabrics were instrumentally assessed with a Datacolor reflection spectrometer Model Type SF500 before the first wash and after each subsequent cycle. Each stain was measured four times on different spots of the fabric, and the obtained readings were averaged subsequently. From the reflection data Y lightness values as well as readings on L*,a*,b* were derived. Data were expressed in a ΔΔY value, which was obtained by subtracting the respective Y reading on each stain before wash and after wash/illumination. Furthermore, the readings were corrected for the bleach effect on the stain of just wash and illumination without any presence of photocatalyst. Therefore, to eliminate the background bleach effect on each stain, corrected values for ΔΔY were calculated. As a consequence, comparisons among series and of different stains were now possible. For representative test results see below (the higher the value the more bleaching effect is seen. For visual discrimination of samples values of ΔΔY>1-2 are required)

TABLE 1
Photobleaching effects after 3 wash cycles on Tea Empa 167

| | Tea Empa 167 |
|---|---|
| Example No. | ΔΔY |
| 1 | 7.5 |
| 2 | 6.8 |
| 3 | 4.8 |
| 4 | 4.8 |
| 6 | 3.6 |
| 8 | 2.7 |
| 10 | 4.1 |
| 11 | 3.4 |
| 12 | 2.5 |
| 13 | 4.7 |
| 14 | 4.1 |

TABLE 2
Photobleaching effects after 3 wash cycles on Coffee wfk 10 K

| | Coffee WFK 10 K |
|---|---|
| Example No. | ΔΔY |
| 2 | 2.0 |
| 8 | 2.1 |
| 20 | 3.7 |

TABLE 3
Photobleaching effects after 3 wash cycles on Coffee CFT C-BC-02

| | Coffee CFT C-BC-02 |
|---|---|
| Example No. | ΔΔY |
| 1 | 3.7 |
| 2 | 3.6 |
| 3 | 3.0 |
| 7 | 3.1 |
| 8 | 2.7 |
| 9 | 2.3 |
| 10 | 3.9 |
| 20 | 2.2 |

TABLE 4
Photobleaching effects after 3 wash cycles on Red Wine Empa 114

| | Red Wine Empa 114 |
|---|---|
| Example No. | ΔΔY |
| 1 | 2.7 |
| 2 | 3.1 |
| 4 | 2.4 |
| 5 | 3.5 |
| 8 | 4.0 |
| 9 | 2.7 |
| 10 | 7.0 |
| 20 | 4.1 |

### Fabric Staining

As a general test method, 0.5 g of the tested liquid laundry formulation was placed directly on a 10 g cotton renforce 1-3005 swatch (round shaped 5 cm diameter area in the center of the swatch) and left completely undisturbed for 30 min exposure time. Afterwards, the swatches were subjected to a standard Linitest cycle (conditions see above). The staining effect could be directly evaluated by visual comparison of swatches. Furthermore, each stain and also the surrounding, non-treated fabric were instrumentally assessed as discussed above and the difference in both data points expressed in ΔE units. The visual difference on the spot and on the background should be as little as possible. For representative test results see below (the higher the value the more staining effect is seen. For visual discrimination of the stain from the surrounding white fabric values of ΔE>1 are required. For all tested compounds values of ΔE<1 are found and thus represent the nonstaining property.

TABLE 5
Fabric staining properties after 30 minutes exposure time

| | Stain to white fabric after wash |
|---|---|
| Example No. | ΔE |
| 2 | 0.71 |
| 3 | 0.80 |
| 4 | 0.79 |
| 5 | 0.79 |
| 6 | 0.72 |
| 11 | 0.89 |
| 12 | 0.85 |
| 13 | 0.83 |
| 14 | 0.80 |
| 15 | 0.80 |
| 16 | 0.66 |
| 17 | 0.73 |

Build-Up after Multiple Wash Cycles

Washing conditions were: 3fold wash, 0.2 g detergent ECE77 w/o optical brightener, liquor ratio 13:1 (100 mL liquor), 15 min, 30° C., 10.0 g ballast cotton renforce 1-3005. The test compounds were added as diluted liquid to the wash liquor. After each wash cycle the fabrics were rinsed for 5 min at 30° C. with 200 mL water, centrifuged and ironed. The fabrics were instrumentally assessed with a Datacolor reflection spectrometer Model Type SF500 before the first wash and after each subsequent cycle. Each fabric sample was measured four times on different spots of the fabric, and the obtained readings were averaged subsequently. From the reflection data readings on L*,a*,b* were derived and expressed in ΔE values. For representative test results see below (the higher the value the more staining effect is seen. For visual discrimination from the reference white fabric without additive values of ΔE>1 are required. For all tested compounds values of ΔE<1 are found and thus no visual build-up observed.

TABLE 6
Build-up data after 10 fold wash

| | 10 fold wash |
|---|---|
| Example No. | ΔE to nil additive |
| 2 | 0.44 |
| 4 | 0.90 |
| 5 | 0.82 |
| 11 | 0.35 |
| 12 | 0.74 |
| 13 | 0.63 |
| 14 | 0.55 |
| 15 | 0.41 |
| 16 | 0.47 |
| 17 | 0.42 |

1.-12. (canceled)

13. A photobleach agent for the removal of stains and soil on textile materials which comprises an ortho substituted compound of formula Ia or Ib and their position isomers 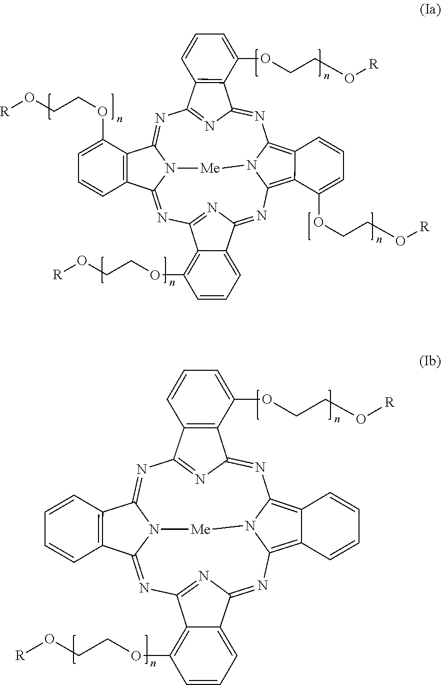
wherein
Me is Zn or Al—X,
X is halogen, OH or O—CH₂—CH₂—OR,
R is H or C₁-C₈alkyl and
n is a number from 1 to 80.

14. The photobleach agent as claimed in claim 13, wherein R is H or CH₃.

15. The photobleach agent as claimed in claim 13, wherein the agent is of formula (Ia)

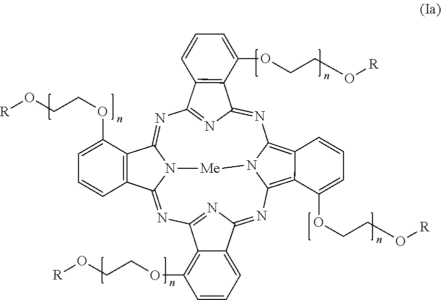

16. The photobleach agent as claimed in claim 13, wherein n is a number from 7 to 70.

17. The photobleach agent as claimed in claim 13, wherein n is a number from 7 to 40.

18. An aqueous cleaning, washing or bleaching process which comprises utilizing the photobleach agent as claimed in claim 13.

19. A detergent, cleaning, washing or bleaching composition comprising
I) from 1 to 50 wt-%, based on the total weight of the composition, A) of at least one anionic surfactant and/or B) of a non-ionic surfactant,
II) from 0 to 70 wt-%, based on the total weight of the composition, C) of at least one builder substance,
III) 0-99 wt-%, based on the total weight of the composition, D) of at least one peroxide and/or one peroxide-forming substance,
IV) E) at least 0.001% to 10% based on the total weight of the composition of at least one compound of formula (Ia) or (Ib) as defined in claim 13,
V) 0-20 wt-%, based on the total weight of the composition, of at least one further additive, and
VI) water.

20. A granule comprising
a) from 1-99 wt-%, based on the total weight of the granule, of at least one compound of formula (Ia) or (Ib) 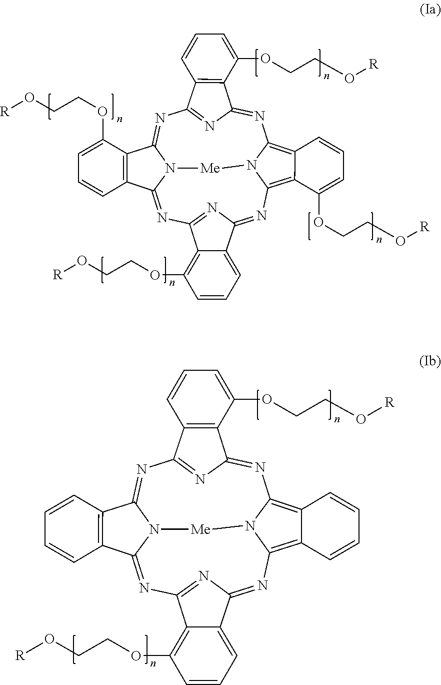
wherein
Me is Zn or Al—X,
X is halogen, OH or O—CH₂—CH₂—OR,
R is H or C₁-C₈alkyl and
n is a number from 1 to 80,
b) from 1-99 wt-%, based on the total weight of the granule, of at least one binder,
c) from 0-20 wt-%, based on the total weight of the granule, of at least one encapsulating material,
d) from 0-20 wt-%, based on the total weight of the granule, of at least one further additive and
e) from 0-20 wt-% based on the total weight of the granule, of water, the components adding to a total of 100%.

21. A composition in liquid form comprising
(a) 0.01-95 wt-%, of a phthalocyanine compound of formula (Ia) or (Ib) as defined in claim 13, based on the total weight of the liquid formulation,
(b) 5-99.99 wt-%, based on the total weight of the liquid formulation, of at least one solvent,
(c) 0-30 wt-% of an anionic or non-ionic surfactant, based on the total weight of the liquid formulation and
(d) 0-10 wt-%, based on the total weight of the liquid formulation, of at least one further additive, the components adding to a total of 100%.

22. The composition as claimed in claim 21, comprising
5-70 wt-% of a phthalocyanine compound of formula (Ia) or (Ib) based on the total weight of the liquid formulation,
(a) 30-95 wt-%, based on the total weight of the liquid formulation, of at least one solvent,
(b) 0-30 wt-% of an anionic or non-ionic surfactant, based on the total weight of the liquid formulation and
(c) 0-2 wt-%, based on the total weight of the liquid formulation, of at least one further additive, the components adding to a total of 100%.

23. A composition or granule according to claim 17, which is used for the treatment of a textile material.

24. A process for removing stains and soil from textile materials comprising the steps
a) treating a textile material with a detergent, cleaning, washing or bleaching composition comprising at least one compound of formula (Ia) or (Ib) according to claim 13;
b) exposing the treated textile material to actinic radiation;
c) rinsing or washing the textile material.

25. The process according to claim 24 wherein the detergent, cleaning, washing or bleaching composition is a composition as described in claim 17.

26. The process according to claim 24 wherein the actinic radiation comprises UV radiation with a wavelength from 670 nm to 750 nm.

27. An ortho substituted compound of formula IIa and its position isomers 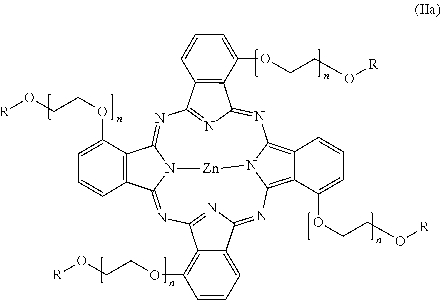
wherein R is H or CH₃ and
n is a number from 7 to 70.
.n is a number from 7 to 70.
